(19) United States
(12) Patent Application Publication
(10) Pub. No.: US 2026/0361470 A1
(43) Pub. Date: Nov. 12, 2026

(54) FREQUENCY RESOURCE ALLOCATION FOR A PHYSICAL CHANNEL WITH MULTIPLE CHANNEL BANDWIDTH SEGMENTS

(71) Applicant: SHARP KABUSHIKI KAISHA, Sakai City (JP)

(72) Inventors: Tomoki Yoshimura, Camas, WA (US); Zhanping Yin, Vancouver, WA (US)

(21) Appl. No.: 19/204,317

(22) Filed: May 9, 2025

(51) Int. Cl. H04L 5/00; H04L 1/00; H04W 72/1273

(52) U.S. Cl. CPC H04L 5/0005; H04L 1/0071; H04L 5/0048; H04W 72/1273

(57) ABSTRACT

A process for a user equipment (UE) is provided. The process receives, from a base station (BS), information defining first and second time and frequency physical resource block (PRB)/virtual resource block (VRB) bundle grids for allocating resources to a physical transmission channel. The process assigns a first group of VRB bundle indices associated with a first channel bandwidth segment of the physical transmission channel. The process assigns a second group of VRB bundle indices associated with a second channel bandwidth segment of the physical transmission channel. The process maps the first group of VRB bundle indices into a first group of PRB resource block bundles in the first time and frequency PRB/VRB bundle grid. The process maps the second group of VRB bundle indices into a second group of PRB resource block bundles in the second time and frequency PRB/VRB bundle grid.

### TECHNICAL FIELD

The technology generally relates to wireless communications, and more particularly to assigning resource block groups (RBGs), precoding resource groups (PRGs), and physical resource blocks (PRBs)/virtual resource blocks (VRBs) to multiple channel bandwidth segments of a physical transmission channel.

### BACKGROUND

Because of the tremendous growth in the number of connected devices and the rapid increase in the user/network (NW) traffic volume, various efforts have been made to improve different aspects of the wireless communications in the next-generation radio communication systems, such as the 5th generation (5G) New Radio (NR). Such improvements include improving data rate, latency, reliability, mobility, etc.

The 5G NR system is designed to provide flexibility and configurability to optimize NW services and types, thus accommodating various use cases, such as enhanced Mobile Broadband (eMBB), massive Machine-Type Communication (mMTC), and Ultra-Reliable and Low-Latency Communication (URLLC).

As the demand for radio access continues to grow, however, there is a need for further improvements in wireless communications in the next-generation radio communication systems.

### SUMMARY

In a first aspect of the present application, a user equipment (UE) is provided. The UE includes one or more non-transitory computer-readable media storing one or more computer-executable instructions. The UE includes at least one processor coupled to the one or more non-transitory computer-readable media, and configured to execute the one or more computer-executable instructions to cause the UE to receive, from a base station (BS), information defining first and second time and frequency PRB/VRB bundle grids for allocating resources to a physical transmission channel; assign a first group of VRB bundle indices associated with a first channel bandwidth segment of the physical transmission channel; assign a second group of VRB bundle indices associated with a second channel bandwidth segment of the physical transmission channel; map the first group of VRB bundle indices into a first group of PRB resource block bundles in the first time and frequency PRB/VRB bundle grid; and map the second group of VRB bundle indices into a second group of PRB resource block bundles in the second time and frequency PRB/VRB bundle grid.

In an implementation of the first aspect, the first group of PRB resource block bundles is not interleaved with the second group of PRB resource block bundles.

In another implementation of the first aspect the first group of VRB bundle indices is mapped into the first group of PRB resource block bundles using a first interleaver, and the second group of VRB bundle indices is mapped into the second group of PRB resource block bundles using a second interleaver.

In another implementation of the first aspect the first interleaver uses a first nominal bundle size defining the number of PRBs in each PRB resource block bundle in the first group of PRB resource block bundles, and the second interleaver uses a second nominal bundle size defining the number of PRBs in each PRB resource block bundle in the second group of PRB resource block bundles.

In another implementation of the first aspect the first and second group of VRB bundle indices are separately mapped into the first and second group of PRB resource block bundles, respectively, using a same interleaver.

In another implementation of the first aspect the physical transmission channel is one of a physical downlink shared channel (PDSCH) a physical uplink shared channel (PUSCH), a physical downlink control channel (PDCCH), or a physical uplink control channel (PUCCH).

In another implementation of the first aspect the at least one processor is further configured to execute the one or more computer-executable instructions to cause the UE to receive, from the BS, the information defining the first and second time and frequency PRB/VRB bundle grids via one of a radio resource control (RRC) signaling, a system information block (SIB), a physical broadcast channel (PBCH), a master information block (MIB), or a downlink control information (DCI).

In another implementation of the first aspect the at least one processor is further configured to execute the one or more computer-executable instructions to cause the UE to transmit, to the BS, an uplink message in the first channel bandwidth segment using the first group of PRB resource block bundles; and transmit, to the BS, an uplink message in the second channel bandwidth segment using the second group of PRB resource block bundles.

In another implementation of the first aspect the at least one processor is further configured to execute the one or more computer-executable instructions to cause the UE to simultaneously transmit, to the BS, an uplink message in the first channel bandwidth segment using the first group of PRB resource block bundles and in the second channel bandwidth segment using the second group of PRB resource block bundles in time division duplex (TDD).

In another implementation of the first aspect the at least one processor is further configured to execute the one or more computer-executable instructions to cause the UE to receive, from the BS, a downlink message in the first channel bandwidth segment using the first group of PRB resource block bundles; and receive, from the BS, a downlink message in the second channel bandwidth segment using the second group of PRB resource block bundles.

In another implementation of the first aspect the at least one processor is further configured to execute the one or more computer-executable instructions to cause the UE to simultaneously receive, from the BS, a downlink message in the first channel bandwidth segment using the first group of PRB resource block bundles and in the second channel bandwidth segment using the second group of PRB resource block bundles in TDD.

In another implementation of the first aspect the first and second channel bandwidth segments are non-contiguous.

In another implementation of the first aspect the at least one processor is further configured to execute the one or more computer-executable instructions to cause the UE to assign the first group of PRB resource block bundles, in an interleaving manner, starting at a first resource block index counted from a first reference point. The number of resource block bundles in a first PRB resource block bundle in the first group of PRB resource block bundles includes a nominal resource block bundle size minus the modulo of the first resource block index and the nominal resource block bundle size of the first channel bandwidth segment. In a case that the modulo of the first resource block index plus the number of resource blocks in the first channel bandwidth segment and the nominal resource block bundle size of the first channel bandwidth segment is greater than zero, the number of resource block bundles in a last PRB resource block bundle in the first group of PRB resource block bundles includes the modulo of the first resource block index plus the number of resource blocks in the first channel bandwidth segment and the nominal resource block bundle size of the first channel bandwidth segment. In a case that the modulo of the first resource block index plus the number of resource blocks in the first channel bandwidth segment and the nominal resource block bundle size of the first channel bandwidth segment is not greater than zero, the number of resource block bundles in the last PRB resource block bundle in the first group of PRB resource block bundles includes the nominal resource block bundle size of the first channel bandwidth segment.

In another implementation of the first aspect, the at least one processor is further configured to execute the one or more computer-executable instructions to cause the UE to assign the second group of PRB resource block bundles, in an interleaving manner, starting at a second resource block index counted from a second reference point. The number of resource block bundles in a first PRB resource block bundle in the second group of PRB resource block bundles includes a nominal resource block bundle size minus the modulo of the second resource group index and the nominal resource block bundle size of the second channel bandwidth segment. In a case that the modulo of the second resource block index plus the number of resource blocks in the second channel bandwidth segment and the nominal resource block bundle size of the second channel bandwidth segment is greater than zero, the number of resource block bundles in a last PRB resource block bundle in the second group of PRB resource block bundles includes the modulo of the second resource block bundle index plus the number of resource blocks in the second channel bandwidth segment and the nominal resource block bundle size of the second channel bandwidth segment. In a case that the modulo of the second resource block index plus the number of resource blocks in the second channel bandwidth segment and the nominal resource block bundle size of the second channel bandwidth segment is not greater than zero, the number of resource block bundles in the last PRB resource block bundle in the second group of PRB resource block bundles includes the nominal resource block bundle size of the second channel bandwidth segment.

In a second aspect of the present application, a method is provided. The method includes receiving, by a UE, from a BS, information defining first and second time and frequency PRB/VRB bundle grids for allocating resources to a physical transmission channel; assigning a first group of VRB bundle indices associated with a first channel bandwidth segment of the physical transmission channel; assigning a second group of VRB bundle indices associated with a second channel bandwidth segment of the physical transmission channel; mapping the first group of VRB bundle indices into a first group of PRB resource block bundles in the first time and frequency PRB/VRB bundle grid; and mapping the second group of VRB bundle indices into a second group of PRB resource block bundles in the second time and frequency PRB/VRB bundle grid.

### BRIEF DESCRIPTION OF THE DRAWINGS

The foregoing and other objects, features, and advantages of the technology disclosed herein will be apparent from the following more particular description of preferred embodiments as illustrated in the accompanying drawings in which reference characters refer to the same parts throughout the various views. The drawings are not necessarily to scale, emphasis instead being placed upon illustrating the principles of the technology disclosed herein.

FIG. 1 is a schematic diagram illustrating an example radio communication system, according to an example implementation of the present disclosure.

FIGS. 2A and 2B are two diagrams illustrating parameters related to SCS-specific carriers, according to an example implementation of the present disclosure

FIG. 3 is a diagram illustrating an example configuration of SCS-specific carriers, according to an example implementation of the present disclosure.

FIG. 4 is a diagram illustrating an example configuration of a resource grid, according to an example implementation and mode of the present disclosure.

FIG. 5 is a schematic block diagram illustrating a configuration example of a base station device, according to an example implementation of the present disclosure.

FIG. 6 is a schematic block diagram illustrating a configuration example of a terminal device, according to an example implementation of the present disclosure.

FIG. 7 is a diagram illustrating an example configuration of a synchronization signal/physical broadcast channel (SS/PBCH) block including a primary synchronization signal (PSS) and a secondary synchronization signal (SSS), according to an example implementation of the present disclosure.

FIG. 8 is a schematic block diagram illustrating logical channel flow in the MAC layer in carrier aggregation, according to an example implementation of the present disclosure.

FIG. 9 illustrates the concept of a single serving cell that includes multiple non-contiguous frequency segments, according to an example implementation of the present disclosure.

FIG. 10 is a diagram illustrating PDSCH mapping in multiple resource grids, where each resource grid is associated with a channel bandwidth segment, according to an example implementation of the present disclosure.

FIG. 11 is a diagram illustrating an example of RB indexing, according to an example implementation of the present disclosure.

FIG. 12 is a diagram illustrating an example of RBG mapping across multiple channel bandwidth segments, according to an example implementation of the present disclosure.

FIG. 13 is a diagram illustrating an example of RBG mapping using a reference point, according to an example implementation of the present disclosure.

FIG. 14 is a diagram illustrating an example of multiple channel bandwidth segments coexisting with incumbent services, according to prior art.

FIG. 15 is a diagram illustrating an example of distributed RB scheduling based on interleaving, according to an example implementation of the present disclosure.

FIG. 16 is a diagram illustrating an example of defining the interleaver unit using a reference point, according to prior art.

FIG. 17 is a diagram illustrating an example of VRB-to-PRB mapping across multiple channel bandwidth segments, according to prior art.

FIG. 18 is a diagram illustrating an example of RBG mapping for multiple channel bandwidth segments using multiple reference points, according to an example implementation of the present disclosure.

FIG. 19 is a flowchart illustrating an example method/process performed by a UE for assigning resource groups to multiple channel bandwidth segments of a physical transmission channel by using multiple different reference points, according to an example implementation of the present disclosure.

FIG. 20 is a flowchart illustrating an example method/process performed by a UE for defining PRB/VRB bundles for multiple channel bandwidth segments of a physical transmission channel by using multiple different reference points, according to an example implementation of the present disclosure.

FIG. 21 is a diagram illustrating an example of VRB-to-PRB mapping for multiple channel bandwidth segments, according to an example implementation of the present disclosure.

FIG. 22 is a flowchart illustrating an example method/process performed by a UE for mapping VRB bundles to PRB bundles for multiple channel bandwidth segments of a physical transmission channel, according to an example implementation of the present disclosure.

FIG. 23 is a block diagram illustrating a node for wireless communication, according to an example implementation of the present disclosure.

### DETAILED DESCRIPTION

Some of the abbreviations in the present application are defined as follows and, unless otherwise specified, the abbreviations have the following meanings:

| Abbreviation | Full name |
|---|---|
| 3GPP | 3rd Generation Partnership Project |
| 5G | 5th Generation |
| 5GC | 5G Core |
| ACK | Acknowledgement |
| AN-PDB | Access Network Packet Delay Budget |
| AS | Access Stratum |
| ASN.1 | Abstract Syntax Notation One |
| BFRQ | Beam Failure Recovery Request |
| BS | Base Station |
| BSR | Buffer Status Report |
| BWP | Bandwidth Part |
| C-RNTI | Cell Radio Network Temporary Identifier |
| CA | Carrier Aggregation |
| CAG | Closed Access Group |
| CB | Codebook-Based |
| CG | Configured Grant |
| CJT | Coherent Joint Transmission |
| CN | Core Network |
| CN-PDB | Core Network Packet Delay Budget |
| CORESET | Control Resource Set |
| CPE | Customer Premises Equipment |
| CRC | Cyclic Redundancy Check |
| CSI | Channel State Information |
| CSI-RS | Channel State Information Reference Signal |
| CS-RNTI | Configured Scheduling Radio Network Temporary |
| | Identifier |
| CSS | Common Search Space |
| CU | Central Unit |
| DAPS | Dual Active Protocol Stack |
| DC | Dual Connectivity |
| DCI | Downlink Control Information |
| DG | Dynamic Grant |
| DI | Delay Information |
| DL | Downlink |
| DL-SCH | Downlink Shared Channel |
| DMRS | Demodulation Reference Signal |
| DR | Delay Report |
| DRB | Data Radio Bearer |
| DTCH | Dedicated Traffic Channel |
| DU | Distributed Unit |
| ETSI | European Telecommunications Standards Institute |
| E-UTRA | Evolved Universal Terrestrial Radio Access |
| EN-DC | E-UTRA NR Dual Connectivity |
| EPC | Evolved Packet Core |
| eMBB | Enhanced Mobile BroadBand |
| eMTC | Enhanced Machine Type Communication |
| eNB | Evolved Node B |
| FDD | Frequency Division Duplexing |
| FR | Frequency Range |
| FR1 | Frequency Range 1 |
| FR2 | Frequency Range 2 |
| FWA | Fixed Wireless Access |
| GEO | Geostationary Equatorial Orbit |
| gNB | Next Generation Node B |
| GNSS | Global Navigation Satellite System |
| GW | Gateway |
| HARQ | Hybrid Automatic Repeat Request |
| HO | Handover |
| FR | Frequency Range |
| IAB | Integrated Access and Backhaul |
| ID | Identity |
| IE | Information Element |
| IoT | Internet of Things |
| ITS | Intelligent Transportation System |
| ITU | International Telecommunication Union |
| L1 | Layer 1 |
| L2 | Layer 2 |
| L3 | Layer 3 |
| LAN | Local Area Network |
| LCH | Logical Channel |
| LCID | Logical Channel Identity |
| LEO | Low Earth Orbit |
| LTE | Long Term Evolution |
| LSB | Least Significant Bit |
| MAC | Medium Access Control |
| MAC CE | MAC Control Element |
| MCG | Master Cell Group |
| MCS | Modulation Coding Scheme |
| MIB | Master Information Block |
| MIMO | Multi-Input Multi-Output |
| mMTC | Massive Machine Type Communications |
| MN | Master Node |
| MTC | Machine Type Communication |
| NACK | Negative Acknowledgement |
| NAS | Non-Access Stratum |
| NB-IoT | Narrow Band Internet of Things |
| NCB | Non-Codebook-Based |
| NDI | New Data Indicator |
| NES | Network Energy Saving |
| NPN | Non-Public Network |
| NR | New Radio |
| NR-U | NR Unlicensed |
| NTN | Non-Terrestrial Network |
| PA | Power Amplifier |
| PBCH | Physical Broadcast Channel |
| PCell | Primary Cell |
| PCI | Physical Cell Identity |
| PDB | Packet Delay Budget |
| PDCCH | Physical Downlink Control Channel |
| PDCP | Packet Data Convergence Protocol |
| PDSCH | Physical Downlink Shared Channel |
| PDU | Protocol Data Unit |
| PHY | Physical |
| PLMN | Public Land Mobile Network |
| PMI | Precoding Matrix indicator |
| PNI-NPN | Public Network Integrated Non-Public Network |
| PRACH | Physical Random Access Channel |
| PSDB | PDU Set Delay Budget |
| PUCCH | Physical Uplink Control Channel |
| PUSCH | Physical Uplink Shared Channel |
| QCL | Quasi-CoLocation |
| QoS | Quality of Service |
| RA | Random Access |
| RACH | Random Access Channel |
| RAN | Radio Access Network |
| RAR | Random Access Response |
| RAT | Radio Access Technology |
| RE | Resource Element |
| Rel-15 | Release 15 |
| RF | Radio Frequency |
| RLC | Radio Link Control |
| RS | Reference Signal |
| RLF | Radio Link Failure |
| RSTD | Reference Signal Time Difference Measurement |
| RNTI | Radio Network Temporary Identifier |
| RO | RACH Occasion |
| RRC | Radio Resource Control |
| RS | Reference Signal |
| RSRP | Reference Signal Received Power |
| RSRQ | Reference Signal Receiving Quality |
| RX | Reception |
| SCell | Secondary Cell |
| SCG | Secondary Cell Group |
| SDT | Small Data Transmission |
| SI | System Information |
| SIB | System Information Block |
| SL | Sidelink |
| SLIV | Start and Length Indicator Value |
| SN | Secondary Node |
| SNPN | Stand-alone Non-Public Network |
| SpCell | Special Cell |
| SR | Scheduling Request |
| SRB | Signaling Radio Bearer |
| SRS | Sounding Reference Signal |
| SRI | SRS Resource Indicator |
| SSB | Synchronization Signal Block |
| SSS | Secondary Synchronization Signal |
| SUL | Supplementary Uplink |
| TA | Timing Advance |
| TAG | Timing Advance Group |
| TAT | Time Alignment Timer |
| TB | Transport Block |
| TCI | Transmission Configuration Indication |
| TDD | Time Division Duplexing |
| TN | Terrestrial Network |
| TPC | Transmission Power Control |
| TPMI | Transmit Precoder Matrix Indication |
| TRP | Transmission Reception Point |
| TRS | Tracking Reference Signal |
| TRX | Transmission/Reception |
| TS | Technical Specification |
| TX | Transmission |
| UCI | Uplink Control Information |
| UE | User Equipment |
| UL | Uplink |
| UL-CG | Uplink-Configured Grant |
| UPF | User Plane Function |
| URLLC | Ultra-Reliable and Low-Latency Communications |
| USIM | Universal Subscriber Identity Module |
| USS | UE-specific Search Space |
| V2X | Vehicle-to-Everything |
| VSAT | Very Small Aperture Terminal |
| XR | Extended Reality |

The following description contains specific information pertaining to example implementations in the present disclosure. The drawings in the present disclosure and their accompanying detailed description are directed to merely example implementations. However, the present disclosure is not limited to merely these example implementations. Other variations and implementations of the present disclosure will occur to those skilled in the art. Unless noted otherwise, like or corresponding elements among the figures may be indicated by like or corresponding reference numerals. Moreover, the drawings and illustrations in the present disclosure are generally not to scale and are not intended to correspond to actual relative dimensions.

For the purposes of consistency and ease of understanding, like features may be identified (although, in some examples, not shown) by the same numerals in the example figures. However, the features in different implementations may differ in other respects, and thus may not be narrowly confined to what is shown in the figures.

The description uses the phrases “in one implementation,” or “in some implementations,” which may each refer to one or more of the same or different implementations. The term “coupled” is defined as connected, whether directly or indirectly through intervening components, and is not necessarily limited to physical connections. The term “comprising,” when utilized, means “including, but not necessarily limited to”; it specifically indicates open-ended inclusion or membership in the so-described combination, group, series, and the equivalent. In addition, the terms “system” and “network” herein may be used interchangeably.

As used herein, the term “and/or” should be interpreted to mean one or more items. For example, the phrase “A, B, and/or C” should be interpreted to mean any of: only A, only B, only C, A and B (but not C), B and C (but not A), A and C (but not B), or all of A, B, and C. As used herein, the phrase “at least one of” should be interpreted to mean one or more items. For example, the phrase “at least one of A, B, and C” or the phrase “at least one of A, B, or C” should be interpreted to mean any of: only A, only B, only C, A and B (but not C), B and C (but not A), A and C (but not B), or all of A, B, and C. As used herein, the phrase “one or more of” should be interpreted to mean one or more items. For example, the phrase “one or more of A, B and C” or the phrase “one or more of A, B or C” should be interpreted to mean any of: only A, only B, only C, A and B (but not C), B and C (but not A), A and C (but not B), or all of A, B, and C.

Any two or more of the following paragraphs, (sub)-bullets, points, actions, behaviors, terms, or claims described in the present disclosure may be combined logically, reasonably, and properly to form a specific method.

Any sentence, paragraph, (sub)-bullet, point, action, behaviors, terms, or claims described in the present disclosure may be implemented independently and separately to form a specific method.

Dependency, e.g., “based on”, “more specifically”, “preferably”, “in one embodiment”, “in some implementations”, etc., in the present disclosure is just one possible example which would not restrict the specific method.

Additionally, for the purposes of explanation and non-limitation, specific details, such as functional entities, techniques, protocols, standard, and the like are set forth for providing an understanding of the described technology. In other examples, detailed descriptions of well-known methods, technologies, systems, architectures, and the like are omitted so as not to obscure the description with unnecessary details.

Persons skilled in the art will immediately recognize that any network function(s) or algorithm(s) described in the present disclosure may be implemented by hardware, software, or a combination of software and hardware. Described functions or algorithms may correspond to modules which may be software, hardware, firmware, or any combination thereof. The software implementation may include computer executable instructions stored on a computer-readable medium, such as a memory or other types of storage devices. For example, one or more microprocessors or general-purpose computers with communication processing capability may be programmed with corresponding executable instructions and carry out the described network function(s) or algorithm(s). The microprocessors or general-purpose computers may include of one or more Application-Specific Integrated Circuits (ASICs), programmable logic arrays, and/or one or more Digital Signal Processor (DSPs). Although some of the example implementations described in this specification are oriented to software installed and executing on computer hardware, nevertheless, alternative example implementations implemented as firmware, as hardware, or as a combination of hardware and software are well within the scope of the present disclosure.

The computer-readable medium includes, but is not limited to, Random Access Memory (RAM), Read Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication network architecture (e.g., a Long-Term Evolution (LTE) system, an LTE-Advanced (LTE-A) system, an LTE-Advanced Pro system, or a 5G NR Radio Access Network (RAN)) typically includes at least one base station (BS), at least one UE, and one or more optional network elements that provide connection towards a network. The UE communicates with the network (e.g., a Core Network (CN), an Evolved Packet Core (EPC) network, an Evolved Universal Terrestrial Radio Access network (E-UTRAN), a 5G Core (5GC), or an internet), through a radio communication network established by one or more BSs.

It should be noted that, in the present disclosure, a UE (or a terminal device) may include, but is not limited to, a mobile station, a mobile terminal or device, a user communication radio terminal. For example, a UE may be a portable radio equipment, which includes, but is not limited to, a mobile phone, a tablet, a wearable device, a sensor, a vehicle, or a Personal Digital Assistant (PDA) with wireless communication capability. The UE is configured to receive and transmit signals over an air interface to one or more cells in a radio access network.

A BS may be configured to provide communication services according to at least one of the following Radio Access Technologies (RATs): Worldwide Interoperability for Microwave Access (WiMAX), Global System for Mobile communications (GSM, often referred to as 2G), GSM Enhanced Data rates for GSM Evolution (EDGE) Radio Access Network (GERAN), General Packet Radio Service (GPRS), Universal Mobile Telecommunication System (UMTS, often referred to as 3G) based on basic wideband-code division multiple access (W-CDMA), high-speed packet access (HSPA), LTE, LTE-A, evolved LTE (eLTE), for example, LTE connected to 5GC, NR (often referred to as 5G), LTE-A Pro, and/or a new radio system referred to as 6G. However, the scope of the present disclosure should not be limited to the above-mentioned protocols.

A BS may include, but is not limited to, a node B (NB) as in the UMTS, an evolved node B (eNB) as in the LTE or LTE-A, a radio network controller (RNC) as in the UMTS, a base station controller (BSC) as in the GSM/GSM Enhanced Data rates for GSM Evolution (EDGE) Radio Access Network (GERAN), a next-generation eNB (ng-eNB) as in an Evolved Universal Terrestrial Radio Access (E-UTRA) BS in connection with the 5GC, a next-generation Node B (gNB) as in the 5G Access Network (5G-AN), a 6G Node B (6gNB), and any other apparatus capable of controlling radio communication and managing radio resources within a cell. The BS may connect to serve the one or more UEs through a radio interface to the network.

The BS may be operable to provide radio coverage to a specific geographical area using one or more cells included in the radio communication network. The BS may support the operations of the cells. Each cell may be operable to provide services to at least one UE within its radio coverage. Specifically, each cell (often referred to as a serving cell) may provide services to serve one or more UEs within its radio coverage (e.g., each cell may correspond to the Downlink (DL) and optionally Uplink (UL) resources to at least one UE within its radio coverage for DL and optionally UL packet transmission). The BS may communicate with one or more UEs in the radio communication system through the cells.

A cell may correspond to sidelink (SL) resources for supporting Proximity Service (ProSe) or Vehicle to Everything (V2X) services. Each cell may have overlapped coverage areas with other cells.

As discussed above, the frame structure for NR or 6G is to support flexible configurations for accommodating various next generation communication requirements, such as Enhanced Mobile Broadband (eMBB), Massive Machine Type Communication (mMTC), Ultra-Reliable and Low-Latency Communication (URLLC), while fulfilling high reliability, high data rate and low latency requirements. The Orthogonal Frequency-Division Multiplexing (OFDM) technology as agreed in the 3^{rd} Generation Partnership Project (3GPP) may serve as a baseline for NR or 6G waveform. The scalable OFDM numerology, such as the adaptive sub-carrier spacing, the channel bandwidth, and the Cyclic Prefix (CP) may also be used. Additionally, two coding schemes are considered for NR or 6G: (1) Low-Density Parity-Check (LDPC) code and (2) Polar Code. The coding scheme adaption may be configured based on the channel conditions and/or the service applications.

Moreover, it should also be noted that in a transmission time interval of a single NR or 6G frame, a DL transmission period, a guard period, and UL transmission data may at least be included, where the respective portions of the DL transmission data, the guard period, and the UL transmission data should also be configurable, for example, based on the network dynamics of NR or 6G. In addition, sidelink resources may also be provided in an NR or 6G frame to support ProSe services, (E-UTRA/NR) sidelink services, or (E-UTRA/NR) V2X services.

A UE configured with multi-connectivity may connect to a Master Node (MN) as an anchor and one or more Secondary Nodes (SNs) for data delivery. Each one of these nodes may be formed by a cell group that includes one or more cells. For example, a Master Cell Group (MCG) may be formed by an MN, and a Secondary Cell Group (SCG) may be formed by an SN. In other words, for a UE configured with dual connectivity (DC), the MCG may be a set of one or more serving cells including the PCell and zero or more secondary cells. Conversely, the SCG may be a set of one or more serving cells including the PSCell and zero or more secondary cells.

As also described above, the Primary Cell (PCell) may be an MCG cell that operates on the primary frequency, in which the UE either performs the initial connection establishment procedure or initiates the connection reestablishment procedure. In the DC mode, the PCell may belong to the MN. The Primary SCG Cell (PSCell) may be an SCG cell in which the UE performs random access (e.g., when performing the reconfiguration with a sync procedure). In Multi-RAT Dual Connectivity (MR-DC), the PSCell may belong to the SN. A Special Cell (SpCell) may be referred to a PCell of the MCG, or a PSCell of the SCG, depending on whether the Medium Access Control (MAC) entity is associated with the MCG or the SCG. Otherwise, the term Special Cell may refer to the PCell. A Special Cell may support a Physical Uplink Control Channel (PUCCH) transmission and contention-based Random Access, and may always be activated. Additionally, for a UE in a radio resource control connected (RRC_CONNECTED) state that is not configured with the carrier aggregation/dual connectivity (CA/DC), may communicate with only one serving cell (SCell) which may be the primary cell. Conversely, for a UE in the RRC_CONNECTED state that is configured with the CA/DC a set of serving cells including the special cell(s) and all of the secondary cells may communicate with the UE.

Some mathematical expressions used in the present application are provided below.

Floor (CX) represents a floor function for the real number CX. For example, floor (CX) may represent a function that provides the largest integer within a range that does not exceed the real number CX.

Ceil (DX) represents a ceiling function to a real number DX. For example, ceil (DX) may be a function that provides the smallest integer within the range not less than the real number DX.

Mod (EX, FX) represents a function that provides the remainder obtained by dividing EX by FX.

Exp (GX) represents e\hat{ }GX. Here, e is the Napier number. Also, (HX)\hat{ }(IX) indicates IX to the power of HX.

According to one aspect of the present disclosure, a waveform formed based on the OFDM may be used in a radio communication system. An OFDM symbol defines a unit in the time domain of the waveform. Each OFDM symbol is converted to a time-continuous signal during a baseband signal generation. For example, the cyclic prefix-OFDM (CP-OFDM) may be used in the downlink transmission of the radio communication system. For example, either CP-OFDM or Discrete Fourier Transform-spread-Orthogonal Frequency Division Multiplex (DFT-s-OFDM) may be used in the uplink transmission of the radio communication system.

It should be noted that the term transmission reception point (TRP) in the present disclosure may be replaced by ‘beam’ or ‘panel’. It should also be noted that the term ‘overlap’ may refer to time domain overlapping or frequency domain overlapping.

Examples of some selected terms in the present disclosure are provided as follows.

Antenna Panel: It may be assumed that an antenna panel is an operational unit for controlling a transmit spatial filter/beam. An antenna panel typically includes several antenna elements. A beam may be formed by an antenna panel. In some embodiments, two antenna panels may be needed in order to form two beams. In other embodiments, one antenna panel may form multiple beams. Such simultaneous beamforming from multiple antenna panels is subject to the UE capability. A similar definition for “antenna panel” may be possible by applying spatial receiving filtering characteristics.

BWP: A subset of the total bandwidth is referred to as a bandwidth part (BWP), and bandwidth adaptation (BA) is achieved by configuring the UE with BWP(s) and telling the UE which of the configured BWPs is currently the active one. To enable BA on the PCell, the gNB configures the UE with UL and DL BWP(s). To enable BA on the SCells in case of the CA, the gNB configures the UE at least with the DL BWP(s) (e.g., there may be no BWP in the UL). For the PCell, the initial BWP is the BWP used for an initial access. The UE may be configured with a first active uplink BWP, for example, by a firstActiveUplinkBWP IE. If the first active uplink BWP is configured for an SpCell, the firstActiveUplinkBWP information element (IE) field may contain the ID of the UL BWP to be activated upon performing the RRC (re-)configuration. If the firstActiveUplinkBWP IE field is absent, the RRC (re-)configuration may not impose a BWP switch. If the first active uplink BWP is configured for an SCell, the firstActiveUplinkBWP IE field may contain the ID of the UL BWP to be used upon the MAC-activation of an SCell.

TCI state: A transmission configuration indication (TCI) state may contain parameters for configuring a Quasi-CoLocation (QCL) relationship between one or more reference signals and a target reference signal set. For example, a target reference signal set may be the Demodulation Reference Signal (DM-RS) ports of the Physical Downlink Shared Channel (PDSCH), Physical Downlink Control Channel (PDCCH), PUCCH or Physical Uplink Shared Channel (PUSCH). The one or more reference signals may include UL or DL reference signals. In NR Rel-15/16, the TCI state is used for DL QCL indication whereas spatial relation information is used for providing UL spatial transmission filter information for UL signal(s) or UL channel(s). Here, a TCI state may refer to information provided similar to spatial relation information, which could be used for UL transmission. In other words, from the UL perspective, a TCI state provides a UL beam information which may provide the information for a relationship between a UL transmission and a DL (or a UL) reference signal (e.g., Channel State Information Reference Signal (CSI-RS), Synchronization Signal Block (SSB), Sounding Reference Signal (SRS), Phase Tracking Reference signal (PTRS)).

A UE may be configured with a list including up to M TCI state configurations, where each TCI state may contain parameters for configuring at least one QCL relationship between one or more downlink reference signals and the DM-RS ports of the PDSCH, the DM-RS port of PDCCH, or the CSI-RS port(s) of a CSI-RS resource. The QCL types corresponding to each DL RS may be given, for example, by the higher layer (e.g., RRC layer), parameters for the at least one RS and may take one of the following values:
‘QCL-TypeA’: {Doppler shift, Doppler spread, average delay, delay spread}
‘QCL-TypeB’: {Doppler shift, Doppler spread}
‘QCL-TypeC’: {Doppler shift, average delay}
‘QCL-TypeD’: {Spatial reception (Rx) parameter}

Furthermore, a UE may be configured with a TCI state configuration that contains parameters for determining a UL transmission (TX) spatial filter for the UL transmissions. More specifically, when signals transmitted from different antenna ports share channels with similar properties, the antenna ports are said to be QCL. Basically, the QCL concept is introduced to help the UE with a receiver procedures including spatial demultiplexing and channel estimation, frequency offset error estimation, synchronization procedures, and beam selection.

Panel: The UE panel information may be derived from the TCI state/UL beam indication information or from the network signaling.

Beam: The term “beam” may be replaced with spatial filter or spatial Rx parameter. For example, when a UE reports a preferred gNB TX beam, the UE is essentially selecting a spatial filter used by the gNB. The term “beam information” may be used to provide information about which beam/spatial filter has been used/selected.

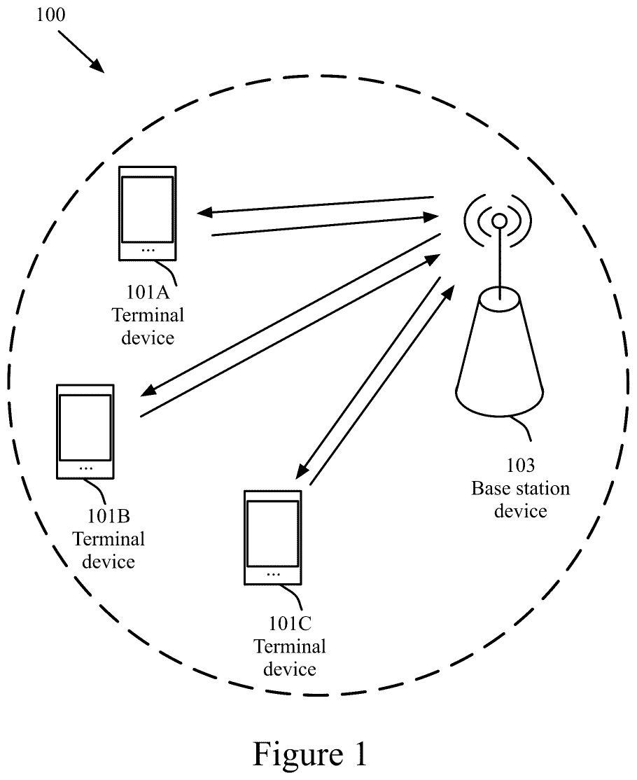

FIG. 1 is a schematic diagram illustrating an example radio communication system, according to an example implementation of the present disclosure. In FIG. 1, the radio communication system 100 includes the terminal devices 101A to 101C and the base station device 103 (BS 103). The terms base station device, base station, and BS herein may be used interchangeably. The terms terminal device, user equipment, and UE herein may be used interchangeably.

The BS 103 may include one or more transmission/reception devices. When the BS 103 is configured of multiple transmission/reception devices, each of the multiple transmission/reception devices may be arranged at a different position. A transmission/reception device may include a transmission device and/or a reception device.

The BS 103 may serve radio communication and provide one or more cells. A cell is defined as a set of resources used for a wireless communication. A cell may include one or more downlink channel bandwidth segments and one or more uplink channel bandwidth segments.

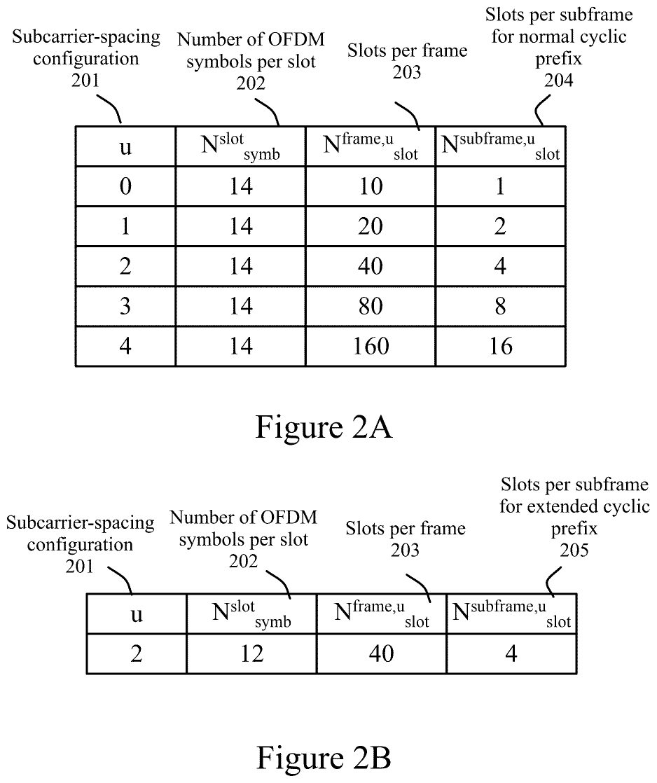

One or more SubCarrier Spacing-specific (SCS-specific) carriers may be associated with one component carrier. Each SCS-specific carrier defines a carrier for a subcarrier-spacing configuration. For example, one SCS-specific carrier may be associated with either a downlink component carrier or an uplink component carrier. In another example, one SCS-specific carrier may be associated with both a downlink component carrier and an uplink component carrier. FIGS. 2A and 2B are two diagrams illustrating parameters related to SCS-specific carriers, according to an example implementation of the present disclosure. In FIGS. 2A and 2B, u 201 represents the subcarrier-spacing configuration. N^{slot}_{symb} 202 represents the number of OFDM symbols in a slot. N^{frame,u}ₛₗₒₜ 203 represents the number of slots in a radio frame. N^{subframe,u}ₛₗₒₜ 204 and N^{subframe,u}ₛₗₒₜ 205 represent the number of slots in a subframe for normal cyclic prefix and extended cyclic prefix, respectively.

In FIG. 2A, for example, when the subcarrier-spacing configuration u 201 is set to 2 and the CP configuration is set to normal CP, the parameters are set to N^{slot}_{symb}=14, N^{frame,u}ₛₗₒₜ=40, and N^{subframe,u}ₛₗₒₜ=4. Further, in FIG. 2B, for example, when the subcarrier-spacing configuration u 201 is set to 2 and the CP configuration is set to an extended CP, the parameters are set to N^{slot}_{symb}=12, N^{frame,u}ₛₗₒₜ=40, N^{subframe,u}ₛₗₒₜ=4.

The time unit T_{c} represents the length of the time domain. The time unit T_{c} may be calculated by 1/(dfₘₐₓ*N_{f}) For example, dfₘₐₓ represents 480 kHz and N_{f}=4096. The constant k may be calculated by dfₘₐₓ*N_{f}/(df_{ref}N_{f,ref}). For example, the constant k may be 64 when df_{ref} is 15 kHz and N_{f,ref} is 2048.

Radio transmissions in the downlink and/or radio transmissions in the uplink may be organized into radio frames (or system frames, frames) of length T_{f}. One radio frame may include ten subframes. The number of OFDM symbols per subframe N^{subframe,u}_{symb} is calculated by N^{slot}_{symb}N^{subframe,u}ₛₗₒₜ.

The SCS of the OFDM-based waveform may be calculated by subcarrier-spacing configuration u. For example, the SCS may be calculated by 15000*2^{u}.

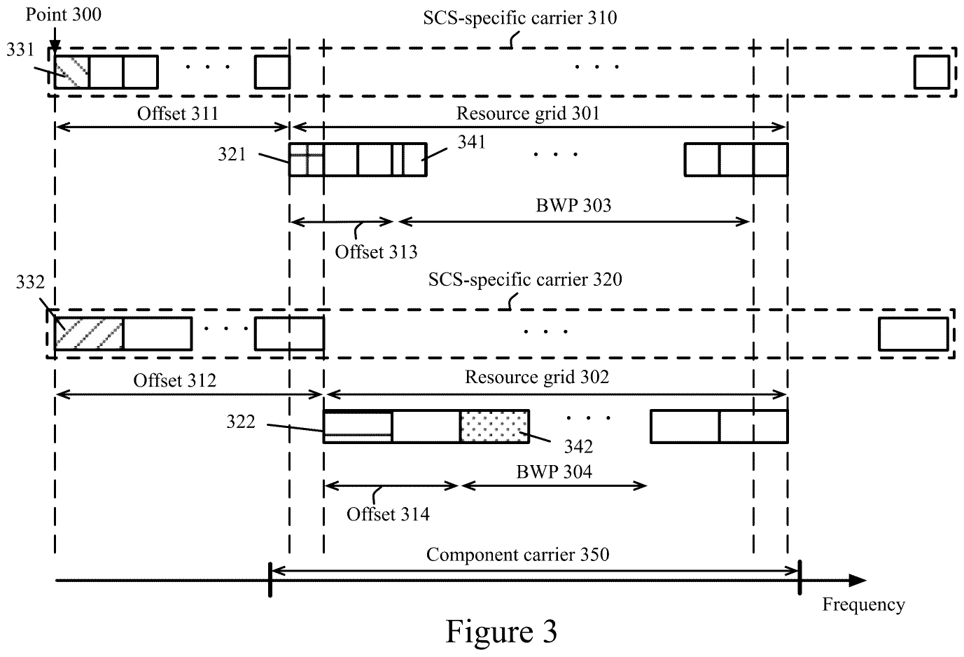

FIG. 3 is a diagram illustrating an example configuration of SCS-specific carriers, according to an example implementation of the present disclosure. The horizontal axis in FIG. 3 represents the frequency domain. FIG. 3 shows a configuration example of two SCS-specific carriers associated with the component carrier 350. In FIG. 3, u₁=u₂−1 is assumed. In some embodiments, the SCS-specific carriers may be channel bandwidth segments.

Point 300 is an identifier for a specific subcarrier. Point 300 is also referred to as Point A. Common resource blocks (CRBs) for SCS-specific carrier 310 are defined with respect to Point 300. The CRB with index 0 is represented by the block 331. CRBs for SCS-specific carrier 320 are defined with respect to Point 300. The CRB with index 0 is represented by the block 332. The CRB with index 0 is defined as the CRB where a subcarrier in the CRB coincides with the subcarrier identified by Point 300.

In FIG. 3, the bandwidth of one CRB in the SCS-specific carrier 310 is a half bandwidth of one CRB in the SCS-specific carrier 320. In other implementations, the bandwidth of one CRB in the SCS-specific carrier 310 may be the same as the bandwidth of one CRB in the SCS-specific carrier 320.

The offset 311 is a Resource Block-level (RB-level) offset from the CRB with index 0 for SCS-specific carrier 310 to the reference point 321 of the resource grid 301. The reference point of the resource grid 301 is the block 321. The offset 312 is an RB-level offset from the CRB with index 0 for SCS-specific carrier 320 to the reference point 322 of the resource grid 302. The reference point of the resource grid 302 is the block 322.

The offset 313 is an RB-level offset from the reference point 321 of the resource grid 301 to the reference point 341 of the Band Width Part (BWP) 303. In some embodiments, the BWP may be a channel bandwidth segment. The reference point of the BWP 303 is the block 341. The offset 314 is an RB-level offset from the reference point 322 of the resource grid 301 to the reference point 342 of the BWP 304. The reference point of the BWP 304 is the block 342.

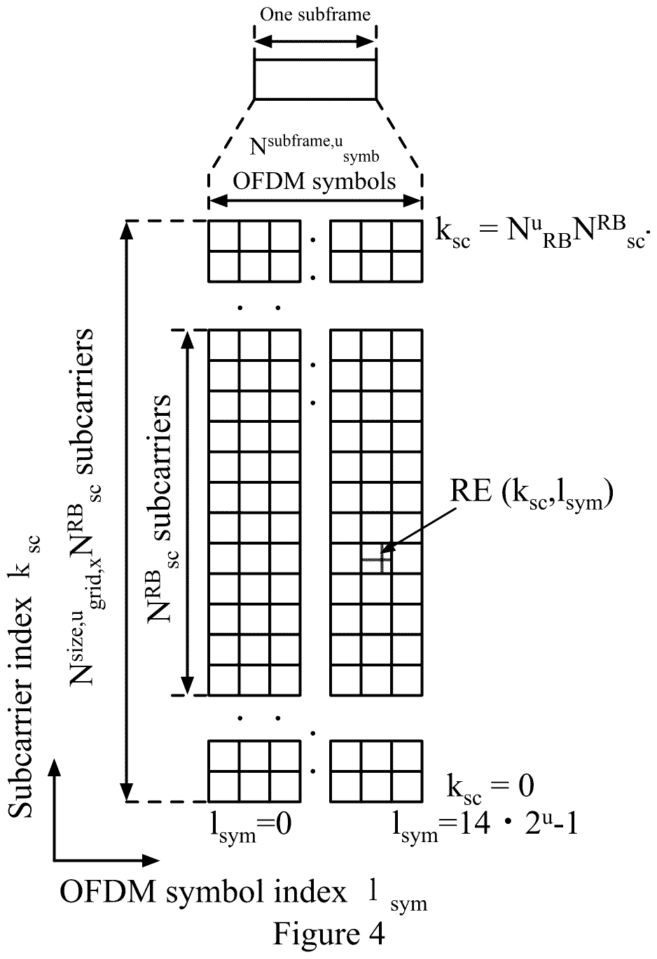

FIG. 4 is a diagram illustrating an example configuration of a resource grid, according to an example implementation and mode of the present disclosure. The horizontal axis represents OFDM symbol index l_{sym}. The vertical axis represents the subcarrier index k_{sc}. The resource grid includes N^{size,u}_{grid,x}N^{RB}_{sc} subcarriers and N^{subframes,u}_{symb} OFDM symbols. A resource specified by the subcarrier index k_{sc} and the OFDM symbol index l_{sym} in a resource grid is also referred to as Resource Element (RE).

A resource block (RB) includes N^{RB}_{sc} consecutive subcarriers. A resource block is a generic name for a CRB, a Physical Resource Block (PRB), and/or a Virtual Resource Block (VRB). In FIG. 4, N^{RB}_{sc} may be 12. CRBs are indexed in ascending order starting at CRB with index 0. PRBs are indexed in ascending order starting at its reference point of the BWP. A BWP is defined as a subset of resource blocks included in the resource grid. The BWP includes N^{size,u}_{BWP,i} resource blocks starting from the reference points of the BWP.

An antenna port may be defined such that the channel over which a symbol on the antenna port is conveyed may be inferred from the channel over which another symbol on the same antenna port is conveyed. The channel may correspond to a physical channel. The symbols may correspond to OFDM symbols. The symbols may correspond to resource block units. The symbols may correspond to resource elements.

Two antenna ports are said to be Quasi Co-Located (QCL) if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial Rx parameters. Carrier aggregation is a framework of communication using multiple aggregated serving cells or using multiple component carriers.

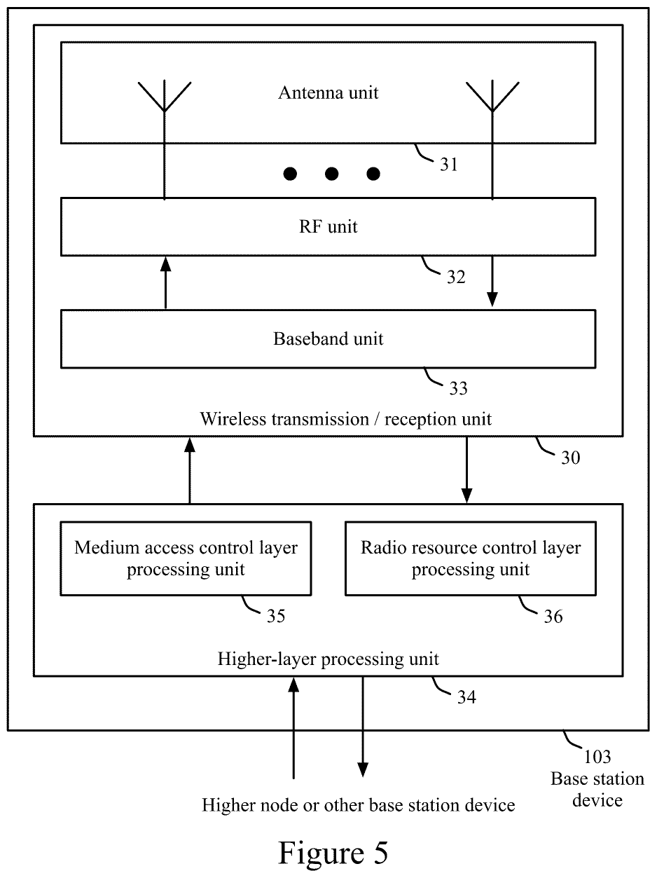

FIG. 5 is a schematic block diagram illustrating a configuration example of a base station device 103, according to an example implementation of the present disclosure. As shown in FIG. 5, the base station device 103 may include a part or all of the wireless transmission and reception unit (also referred to herein as physical layer processing unit) 30 and a higher-layer processing unit 34. The wireless transmission and reception unit 30 may include a part or all of an antenna unit 31, a Radio Frequency (RF) unit 32, and a baseband unit 33. The higher-layer processing unit 34 may include a part or all of a Medium Access Control (MAC) layer processing unit 35 and a Radio Resource Control (RRC) layer processing unit 36.

The wireless transmission and reception unit 30 may include a part (or all) of a wireless transmission unit 30a (not shown in the figure) and a wireless reception unit 30b (not shown in the figure). The configuration of the baseband unit 33 in the wireless transmission unit 30a and the configuration of the baseband unit 33 in the wireless reception unit 30b may be the same or different. The configuration of the RF unit 32 in the wireless transmission unit 30a and the configuration of the RF unit 32 in the wireless reception unit 30b may be the same or different. The configuration of the antenna unit 31 in the wireless transmission unit 30a and the configuration of the antenna unit 31 in the wireless reception unit 30b may be the same or different. The wireless transmission and reception unit 30 may include at least one processor (not shown in the figure) and one or more non-transitory computer-readable media (not shown in the figure) that store computer-executable instructions and data.

The higher-layer processing unit 34 may provide downlink data (e.g., transport blocks) to the wireless transmission and reception unit 30 (or the wireless transmission unit 30a). The higher-layer processing unit 34 may perform the processing of a part or all of the MAC layer, the Packet Data Convergence Protocol (PDCP) layer, the Radio Link Control (RLC) layer and the RRC layer. The higher-layer processing unit 34 may also include at least one processor (not shown in the figure) and one or more non-transitory computer-readable media (not shown in the figure) that store computer-executable instructions and data.

The MAC layer processing unit 35 may perform the processing of the MAC layer. The RRC layer processing unit 36 may perform the processing of the RRC layer. The RRC layer processing unit 36 may manage various RRC parameters of the terminal device 101.

The wireless transmission and reception unit 30 (or the wireless transmission unit 30a) may perform processing, such as encoding and modulation. The wireless transmission and reception unit 30 (or the wireless transmission unit 30a) generates a physical signal by encoding and modulating the downlink data. The wireless transmission and reception unit 30 (or the wireless transmission unit 30a) converts the OFDM symbols in the physical signal to a baseband signal by converting them to a time-continuous signal. The wireless transmission and reception unit 30 (or the wireless transmission unit 30a) transmits the baseband signal (or the physical signal) to the terminal device 101 via radio frequency. The wireless transmission and reception unit 30 (or the wireless transmission unit 30a) may arrange the baseband signal (or the physical signal) on a component carrier and transmit the baseband signal (or the physical signal) to the terminal device 101.

The wireless transmission and reception unit 30 (or the wireless reception unit 30b) may perform processing, such as demodulation and decoding. The wireless transmission and reception unit 30 (or the wireless reception unit 30b) separates, demodulates, and decodes the received physical signal, and provides the decoded information to the higher-layer processing unit 34. The wireless transmission and reception unit 30 (or the wireless reception unit 30b) may perform the channel access procedure prior to the transmission of the physical signal.

The RF unit 32 demodulates the radio signal received via the antenna unit 31 into an analog signal, and/or removes the extra frequency components. The RF unit 32 provides the processed analog signal to the baseband unit 33.

The baseband unit 33 converts the analog signal input from the RF unit 32 into a baseband signal. The baseband unit 33 separates a portion which corresponds to the CP from the baseband signal. The baseband unit 33 performs Fast Fourier Transformation (FFT) on the baseband signal from which the CP has been removed. The baseband unit 33 extracts components of the physical signal from the baseband signal. The baseband unit 33 performs Inverse Fast Fourier Transformation (IFFT) on the downlink data to generate time-continuous signal, adds a CP to the generated signal, generates a baseband signal, and converts the baseband signal into an analog signal. The baseband unit 33 provides the analog signal to the RF unit 32.

The RF unit 32 removes the extra frequency components from the analog signal input from the baseband unit 33, up-converts the analog signal to a radio frequency, and transmits it via the antenna unit 31. The RF unit 32 may have the function of controlling transmission power.

The terminal device 101 may configure one or more downlink BWPs per serving cell. The terminal device 101 may configure one or more uplink BWPs per serving cell.

The terminal device 101 may try to detect a Physical Downlink Shared Channel (PDSCH), a Physical Downlink Control Channel (PDCCH), and a Channel State Information-Reference Signal (CSI-RS) in the active downlink BWP. The terminal device 101 may transmit a Physical Uplink Control Channel (PUCCH) and a Physical Uplink Shared Channel (PUSCH) in the active uplink BWP. The active downlink BWP and the active uplink BWP are also referred to as active BWP.

The terminal device 101 may not receive the PDSCH, PDCCH, and CSI-RS in the downlink BWPs other than the active downlink BWP. The terminal device 101 may not transmit the PUCCH and PUSCH in the uplink BWPs other than the active uplink BWP. BWPs other than the active BWP is referred to as inactive BWPs.

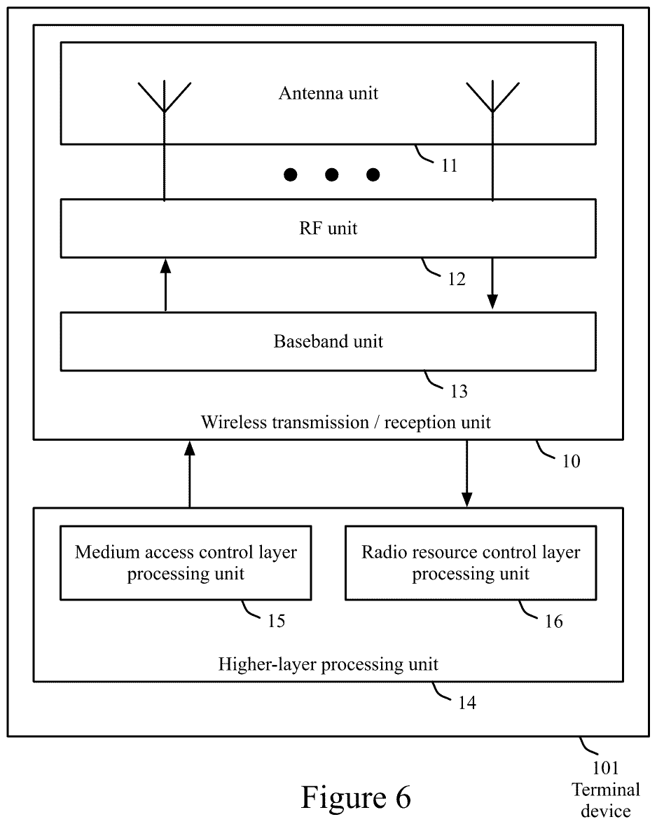

FIG. 6 is a schematic block diagram illustrating a configuration example of a terminal device, according to an example implementation of the present disclosure. The terminal device 101 may be any of the terminal devices 101A-101C, shown in FIG. 1. As shown in FIG. 6, the terminal device 101 may include a part or all of the wireless transmission and reception unit (also referred to herein as physical layer processing unit or physical layer unit) 10 and the higher-layer processing unit 14. The wireless transmission and reception unit 10 may include a part or all of the antenna unit 11, the RF unit 12, and the Baseband unit 13. The higher-layer processing unit 14 may include a part or all of the MAC layer processing unit (also referred to as the MAC entity) 15 and the RRC layer processing unit 16. The higher-layer processing unit 14 may include at least one processor (not shown in the figure) and one or more non-transitory computer-readable media (not shown in the figure) that store computer-executable instructions and data.

The wireless transmission and reception unit 10 may include a part of or all of the wireless transmission unit 10a (not shown in the figure) and the wireless reception unit 10b (not shown in the figure). The wireless transmission and reception unit 10 may include at least one processor (not shown in the figure) and one or more non-transitory computer-readable media (not shown in the figure) that store computer-executable instructions and data.

The configuration of the baseband unit 13 in the wireless transmission unit 10a and the configuration of the baseband unit 13 in the wireless reception unit 10b may be the same or different. The configuration of the RF unit 12 in the wireless transmission unit 10a and the RF unit 12 in the wireless reception unit 10b may be the same or different. The configuration of the antenna unit 11 in the wireless transmission unit 10a and the configuration of the antenna unit 11 in the wireless reception unit 10b may be the same or different.

The higher-layer processing unit 14 provides uplink data (transport blocks) to the wireless transmission and reception unit 10 (or the wireless transmission unit 10a). The higher-layer processing unit 14 may perform processing of the MAC layer, the PDCP layer, the RLC layer, and/or the RRC layer.

The MAC layer processing unit 15 in the higher-layer processing unit 14 may perform processing of the MAC layer. RRC layer processing unit 16 in the higher-layer processing unit 14 may perform the process of the RRC layer. RRC layer processing unit 16 manages various RRC parameters of the terminal device 101 based on RRC messages received from the base station device 103.

The wireless transmission and reception unit 10 (or the wireless transmission unit 10a) may perform processing, such as encoding and modulation. The wireless transmission and reception unit 10 (or the wireless transmission unit 10a) may generate a physical signal by encoding and modulating the uplink data. The wireless transmission and reception unit 10 (or the wireless transmission unit 10a) may convert OFDM symbols in the physical signal to a baseband signal by conversion to a time-continuous signal. The wireless transmission and reception unit 10 (or the wireless transmission unit 10a) may transmit the baseband signal (or the physical signal) to the base station device 103 via radio frequency. The wireless transmission and reception unit 10 (or the wireless transmission unit 10a) may arrange the baseband signal (or the physical signal) on a BWP (active uplink BWP) and transmit the baseband signal (or the physical signal) to the base station device 103.

The wireless transmission and reception unit 10 (or the wireless reception unit 10b) performs processing, such as demodulation and decoding. The wireless transmission and reception unit 10 (or the wireless reception unit 10b) may receive a physical signal in a BWP (active downlink BWP) of a serving cell. The wireless transmission and reception unit 10 (or the wireless reception unit 10b) may separate, demodulate, and decode the received physical signal, and provide the decoded information to the higher-layer processing unit 14. The wireless transmission and reception unit 10 (or the wireless reception unit 10b) may perform the channel access procedure prior to the transmission of the physical signal.

The RF unit 12 may demodulate the radio signal received via the antenna unit 11 into an analog signal, and/or removes extra frequency components. The RF unit 12 may provide the processed analog signal to the baseband unit 13. The baseband unit 13 may convert the analog signal input from RF unit 12 into a baseband signal. The baseband unit 13 may separate a portion which corresponds to CP from the baseband signal, perform FFT on the baseband signal from which the CP has been removed. The baseband unit 13 may extract components of the physical signal from the baseband signal.

The baseband unit 13 may perform IFFT on the uplink data to generate time-continuous signal, adds a CP to the generated signal, generate a baseband signal, and convert the baseband signal into an analog signal. The baseband unit 13 may provide the analog signal to the RF unit 12.

The RF unit 12 may remove extra frequency components from the analog signal input from the baseband unit 13, up-converts the analog signal to a radio frequency, and may transmit it via the antenna unit 11. RF unit 12 may have a function of controlling transmission power.

A physical signal is a generic term for physical downlink channels, physical downlink signals, physical uplink channels, and physical uplink signals. The physical channel is a generic term for physical downlink channels and physical uplink channels.

A physical uplink channel corresponds to a set of REs that carry one or both of information originating from the higher-layer and the Uplink Control Information (UCI). In the radio communication system according to one aspect of the present embodiments, a part or all of the PUCCH, PUSCH, and/or a Physical Random Access Channel (PRACH) may be used.

A PUCCH may be used to transmit the UCI. A PUCCH may be sent to deliver (transmit, convey) uplink control information. The UCI may be mapped to the PUCCH. The terminal device 101 may transmit a PUCCH in which the UCI is mapped. The base station device 103 may receive the PUCCH in which the UCI is mapped.

The Channel State Information (CSI) may be deemed as a type of UCI. The CSI is used to convey information related to the propagation path between the terminal device 101 and the base station device 103.

The Hybrid Automatic Repeat request ACKnowledgement (HARQ-ACK) information may also be deemed as a type of UCI. The HARQ-ACK information is used to convey whether the downlink data has been successfully decoded or not.

The Scheduling Request (SR) may also be deemed as a type of UCI. The SR is used to request an uplink resource (a PUSCH or a UL-SCH).

Uplink control information (uplink control information bit, uplink control information sequence, uplink control information type) includes at least part or all of the CSI, SR, and HARQ-ACK.

The CSI may include at least part or all of a channel quality indicator (CQI), a Precoder Matrix Indicator (PMI), and a Rank Indicator (RI). CQI is an indicator related to channel quality (e.g., propagation quality) or physical channel quality, and PMI is an indicator related to a precoder. RI is an indicator related to transmission rank (or the number of transmission layers).

The CSI may be provided at least based on receiving one or more physical signals (e.g., one or more CSI-RSs) used at least for channel measurement. The CSI may be selected by a terminal device at least based on receiving one or more physical signals used for channel measurement. Channel measurements may include interference measurements.

A PUSCH may be used to transmit one or both of a transport block and UCI. A PUSCH may be sent to deliver (transmit, convey) one or both of a transport block and uplink control information. The terminal device 101 may transmit a PUSCH in which one or both of a transport block and UCI is mapped. The base station device 103 may receive the PUSCH in which the one or both of the transport block and the UCI is mapped.

A PRACH may be used to transmit a random-access (RA) preamble. A PRACH may be sent to deliver (transmit, convey) an index of a random-access preamble. The terminal device 101 may transmit a PRACH. The base station device 103 may receive the PRACH.

For a given PRACH occasion (RACH occasion, RO), 64 random-access preambles are defined. The random-access preamble is specified (determined, given) based on the cyclic shift Cᵥ of the PRACH and the sequence index u for the PRACH.

A physical uplink signal corresponds to a set of REs. A physical uplink signal may not carry information generated in the higher-layer. The terminal device 101 may transmit a physical uplink signal. The base station device 103 may receive the physical uplink signal. In the radio communication system according to one aspect of the present embodiment, a part or all of UpLink Demodulation Reference Signal (UL DMRS), SRS (Sounding Reference Signal (SRS), UpLink Phase Tracking Reference Signal (UL PTRS) may be used.

UL DMRS is a generic name of a DMRS for a PUSCH and a DMRS for a PUCCH. A set of antenna ports of a DMRS for a PUSCH may be given based on a set of antenna ports for the PUSCH. For example, a set of DMRS antenna ports for a PUSCH may be the same as a set of antenna ports for the PUSCH.

A PUSCH and a DMRS for the PUSCH is collectively referred to as PUSCH. A set of antenna ports of a DMRS for a PUCCH may be given based on a set of antenna ports for the PUCCH. For example, a set of DMRS antenna ports for a PUCCH may be the same as a set of antenna ports for the PUCCH. A PUCCH and a DMRS for the PUCCH is collectively referred to as PUCCH.

A physical downlink channel corresponds to a set of REs that carry one or both of information originating from the higher-layer and Downlink Control Information (DCI). In the radio communication system according to one aspect of the present embodiment, a part or all of Physical Broadcast Channel (PBCH), Physical Downlink Control Channel (PDCCH), and Physical Downlink Shared Channel (PDSCH) may be used.

A PBCH may be used to transmit a Master Information Block (MIB). A PBCH may be sent to deliver (transmit, convey) a MIB. The terminal device 101 may receive a PBCH. The base station device 103 may transmit the PBCH.

A PDCCH may be used to transmit DCI. A PDCCH may be sent to deliver (transmit, convey) DCI. The terminal device 101 may receive a PDCCH in which DCI is mapped. The base station device 103 may transmit the PDCCH in which the DCI is mapped.

The DCI format includes a set of information fields. Each information field may mask a bit sequence of the DCI. Bits masked by an information field is associated with a specific meaning associated with the information field.

Several DCI formats may be used in the radio communication system according to one aspect of the present embodiment. Several example DCI formats are provided.

DCI format 0_0 is used for scheduling a PUSCH for a cell. The DCI format 0_0 includes a part or all of Information fields 1A to 1E. Information field 1A is a DCI format identification field. Information field 1B is a Frequency Domain Resource Assignment (FDRA) field. Information field 1C is a Time Domain Resource Assignment (TDRA) field. Information field 1D is a frequency-hopping flag field. Information field 1E is a Modulation-and-Coding-Scheme (MCS) field.

A DCI format identification field may indicate whether a DCI format including the DCI format identification field is an uplink DCI format or a downlink DCI format. The DCI format identification field included in the DCI format 0_0 indicates that the DCI format 0_0 is an uplink DCI format.

A FDRA field in a DCI format may be used to indicate assignment of frequency resources for a physical channel scheduled by the DCI format. For example, the FDRA field may indicate the number of RBs, X, for PUSCH.

A TDRA field in a DCI format may be used to indicate assignment of time resources for a physical channel scheduled by the DCI format.

A frequency-hopping flag field in a DCI format may be used to indicate whether frequency-hopping is applied to a physical channel scheduled by the DCI format.

A MCS field in a DCI format may be used to indicate one or both of a modulation scheme for a physical channel scheduled by the DCI format and a target code rate for the physical channel. The target code rate is used to determine a Transport Block Size (TBS) for the physical channel.

The DCI format 0_0 may not include fields used for a CSI request. That is, CSI may not be requested by the DCI format 0_0.

The DCI format 0_0 may not include a carrier indicator field. If an uplink DCI format does not include a carrier indicator field, the terminal device 101 may determine that an uplink component carrier on which a PUSCH scheduled by the uplink DCI format is mapped is an uplink component carrier in a serving cell which includes a downlink component carrier on which a PDCCH with the uplink DCI format is mapped.

The DCI format 0_0 may not include a BWP indicator field. If a DCI format does not include a BWP indicator field, the terminal device 101 may determine that active BWP change has not been triggered by the DCI format.

DCI format 0_1 may be used for scheduling of a PUSCH for a cell. The DCI format 0_1 includes a part or all of Information fields 2A to 2H. Information field 2A is a DCI format identification field. Information field 2B is a FDRA field. Information field 2C is a TDRA field. Information field 2D is a frequency-hopping flag field. Information field 2E is an MCS field. Information field 2F is a CSI request field. Information field 2G is a BWP field. Information field 2H is a carrier indicator field.

The DCI format identification field in the DCI format 0_1 may indicate that the DCI format 0_1 is an uplink DCI format.

The CSI request field may be used to request CSI reporting.

If the DCI format 0_1 includes a BWP field, the BWP field may be used to indicate an uplink BWP on which a PUSCH scheduled by the DCI format 0_1 is mapped.

If the DCI format 0_1 includes the carrier indicator field, the carrier indicator field may be used to indicate an uplink component carrier on which a PUSCH is mapped.

DCI format 1_0 may be used for scheduling of a PDSCH for a cell. The DCI format 1_0 includes a part or all of Information fields 3A to 3F. Information field 3A is a DCI format identification field. Information field 3B is a FDRA field. Information field 3C is a TDRA field. Information field 3D is an MCS field. Information field 3E is a PDSCH-to-HARQ-feedback indicator field. Information field 3F is a PUCCH resource indicator field. The DCI format identification field in the DCI format 1_0 indicates that the DCI format 1_0 is a downlink DCI format.

The PDSCH-to-HARQ-feedback timing indicator field may be used to indicate the offset (K1) from a slot in which the last OFDM symbol of a PDSCH scheduled by the DCI format is included to another slot in which the first OFDM symbol of a PUCCH triggered by the DCI format 1_0 is mapped. The PUCCH resource indicator field may be used to indicate a PUCCH resource.

The DCI format 1_0 may not include the carrier indicator field. If a downlink DCI format does not include the carrier indicator field, the terminal device 101 may determine that a downlink component carrier on which a PDSCH scheduled by the downlink DCI format is mapped is the downlink component carrier on which the PDCCH with the DCI format 1_0 is mapped. The DCI format 1_0 may not include the BWP field.

The DCI format 1_1 may be used for scheduling of a PDSCH for a cell. The DCI format 1_1 includes a part or all of Information fields 4A to 4H. Information field 4A is a DCI format identification field. Information field 4B is a FDRA field. The 4C is a TDRA field. Information field 4D is an MCS field. Information field 4E is a PDSCH-to-HARQ-feedback indicator field. Information field 4F is a PUCCH resource indicator field. Information field 4G is a BWP field. Information field 4H is a carrier indicator field. The DCI format identification field in the DCI format 1_1 may indicate that the DCI format 1_1 is a downlink DCI format.

A PDSCH may be used to transmit a transport block. A PDSCH may be sent to deliver (transmit, convey) a transport block. The base station device 103 may transmit a PDSCH. The terminal device 101 may receive the PDSCH.

A physical downlink signal corresponds to a set of REs. A physical downlink signal may not carry the information generated in the higher-layer. The base station 103 transmits a physical downlink signal. The terminal device 101 may receive the physical downlink signal. In the radio communication system according to one aspect of the present embodiment, at least a part or all of a Synchronization signal (SS), DownLink DeModulation Reference Signal (DL DMRS), Channel State Information-Reference Signal (CSI-RS), and DownLink Phase Tracking Reference Signal (DL PTRS) may be used.

A synchronization signal may be used to synchronize in the frequency domain and time domain for downlink. The synchronization signal is a generic name of Primary Synchronization Signal (PSS) and Secondary Synchronization Signal (SSS).

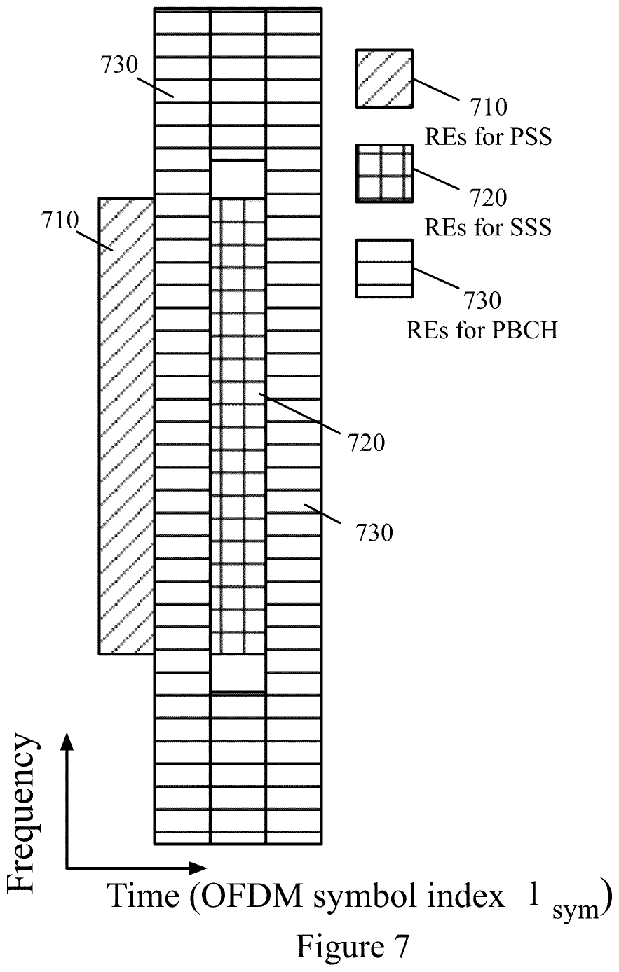

FIG. 7 is a diagram illustrating an example configuration of a synchronization signal/physical broadcast channel (SS/PBCH) block including a primary synchronization signal (PSS) and a secondary synchronization signal (SSS), according to an example implementation of the present disclosure. In FIG. 7, the horizontal axis represents the OFDM symbol index l_{sym}, and the vertical axis represents the frequency domain. The shaded blocks 710 represent a set of REs for the PSS. The block of grid lines 720 represents a set of REs for the SSS. Also, the blocks in the horizontal line 730 represent a set of REs for the PBCH and a set of REs for a DMRS for the PBCH.

The SS/PBCH block in FIG. 7 includes a PSS, an SSS, and a PBCH. The SS/PBCH block includes 4 consecutive OFDM symbols and 240 subcarriers. The PSS is allocated to the 57th to 183rd subcarriers in the first OFDM symbol. The SSS is allocated to the 57th to 183rd subcarriers in the third OFDM symbol. The first to 56th subcarriers of the first OFDM symbol may be set to zero. The 184th to 240th subcarriers of the first OFDM symbol may be set to zero. The 49th to 56th subcarriers of the third OFDM symbol may be set to zero. The 184th to 192nd subcarriers of the third OFDM symbol may be set to zero. In the first to 240th subcarriers of the second OFDM symbol, the PBCH is allocated to subcarriers in which the DMRS for the PBCH is not allocated. In the first to 48th subcarriers of the third OFDM symbol, the PBCH is allocated to subcarriers in which the DMRS for the PBCH is not allocated. In the 193rd to 240th subcarriers of the third OFDM symbol, the PBCH is allocated to subcarriers in which the DMRS for the PBCH is not allocated. In the first to 240th subcarriers of the 4th OFDM symbol, the PBCH is allocated to subcarriers in which the DMRS for the PBCH is not allocated.

The antenna ports of the PSS, the SSS, the PBCH, and the DMRS for the PBCH in an SS/PBCH block may be identical. DL DMRS is a generic name of a DMRS for a PBCH, a DMRS for a PDSCH and a DMRS for a PDCCH.

A set of antenna ports of a DMRS for a PDSCH may be given based on a set of antenna ports for the PDSCH. For example, a set of DMRS antenna ports for a PDSCH may be the same as a set of antenna ports for the PDSCH.

A PDSCH and a DMRS for the PDSCH is collectively referred to as PDSCH. A set of antenna ports of a DMRS for a PDCCH may be given based on a set of antenna ports for the PDCCH. For example, a set of DMRS antenna ports for a PDCCH may be the same as a set of antenna ports for the PDCCH. A PDCCH and a DMRS for the PDCCH is collectively referred to as PDCCH.

A Broadcast Channel (BCH), an Uplink-Shared Channel (UL-SCH). and a Downlink-Shared Channel (DL-SCH) are transport channels. A channel used in the MAC layer is called a transport channel. A unit of transport channel used in the MAC layer is also called transport block (TB) or MAC Protocol Data Unit (MAC PDU). In the MAC layer, control of Hybrid Automatic Repeat request (HARQ) is performed for each transport block. The transport block is a unit of data delivered by the MAC layer to the physical layer. In the physical layer, transport blocks are mapped to codewords and modulation processing is performed for each codeword.

One UL-SCH and one DL-SCH may be provided for each serving cell. BCH may be given to PCell. BCH may not be given to PSCell and SCell.

A Broadcast Control Channel (BCCH), a Common Control Channel (CCCH), and a Dedicated Control Channel (DCCH) are logical channels. The BCCH is a channel of the RRC layer used to deliver MIB or system information. The CCCH may be used to transmit a common RRC message in multiple terminal devices. The DCCH may be used to transmit a dedicated RRC message to a terminal device.

The BCCH in the logical channel may be mapped to the BCH or the DL-SCH in the transport channel. The CCCH in the logical channel may be mapped to the DL-SCH or the UL-SCH in the transport channel. The DCCH in the logical channel may be mapped to the DL-SCH or the UL-SCH in the transport channel.

The UL-SCH in the transport channel may be mapped to a PUSCH in the physical channel. The DL-SCH in the transport channel may be mapped to a PDSCH in the physical channel. The BCH in the transport channel may be mapped to a PBCH in the physical channel.

A higher-layer parameter is a parameter in an RRC message or a MAC CE (Control Element). A higher-layer parameter may be a cell-specific parameter or a UE-specific parameter. A cell-specific parameter is a parameter including a common configuration in a cell. A UE-specific parameter is a parameter including a configuration that may be configured differently for each UE.

The BS 103 may indicate change of cell-specific parameters by reconfiguration with random-access. The BS 103 may indicate change of UE-specific parameters by reconfiguration with or without random-access.

### Assigning Frequency Resources for a Physical Channel Having Multiple Channel Bandwidth Segments

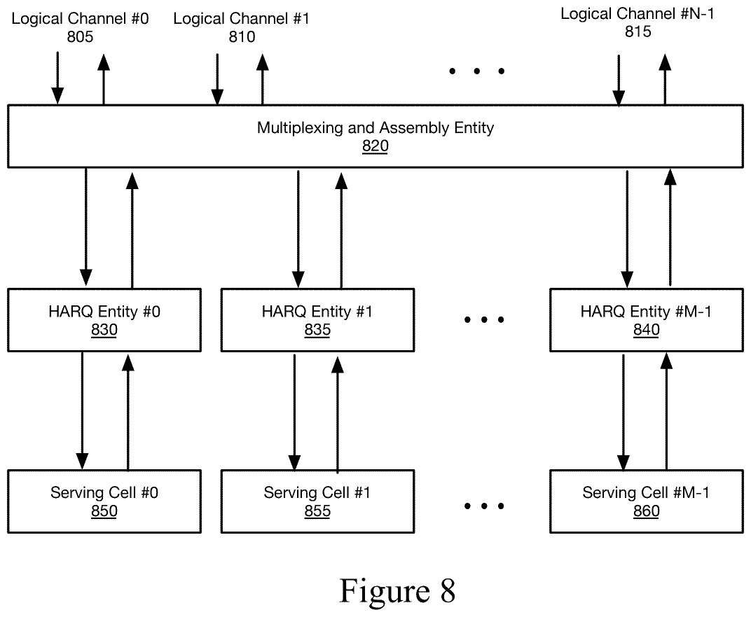

FIG. 8 is a schematic block diagram illustrating logical channel flow in the MAC layer in carrier aggregation, according to an example implementation of the present disclosure. Data sequences in logical channels 805-815 may be input to the multiplexing and assembly entity 820. The sequences may be multiplexed and distributed to the Hybrid Automatic Repeat request (HARQ) entities 830-840. Each HARQ entity 830-840 may manage soft buffers (or HARQ buffers), for example, for uplink. Each HARQ entity 830-840 may be mapped to one serving cell 850-860 in a one-to-one manner.

The HARQ entities 830-840 may handle physical channel transmissions and retransmissions which support HARQ. This limitation prohibits the following features: (1) a single physical channel (e.g., a PDSCH) to be mapped to more than one serving cells and (2) the retransmission(s) of a single physical channel in a different cell (also referred to as cross-carrier HARQ). To support the features above, assuming that the HARQ entity definition does not change (e.g., one HARQ entity per serving cell) in the communication networks, a single serving cell that includes multiple non-contiguous frequency segments may be used.

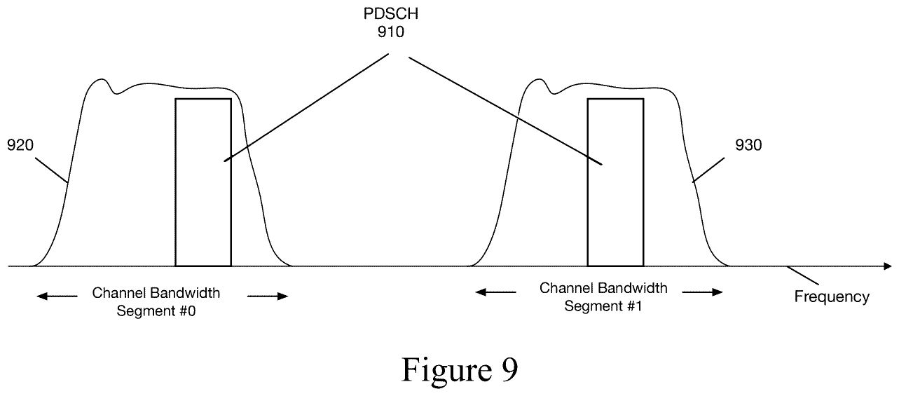

FIG. 9 illustrates the concept of a single serving cell that includes multiple non-contiguous frequency segments, according to an example implementation of the present disclosure. In FIG. 9, channel bandwidth segment #0 and channel bandwidth segment #1 are two frequency segments, which are apart from each other. A channel bandwidth segment, in some embodiments, may be a SCS-specific carrier, such as the SCS-specific carriers 310 and 320, described above with reference to FIG. 3. A channel bandwidth segment, in some embodiments, may be a BWP, such as BWP as BWPs 303 and 304, described above with reference to FIG. 3. Curve lines 920 and 930 represent RF/digital frequency domain filtering responses. In the figure, a single PDSCH 910 is distributed to the two channel bandwidth segments #0 and #1, which may exploit more frequency diversity. It should be noted that although the number of channel bandwidth segments (and their corresponding reference points) in this figure and other figures of the present disclosure are shown as two channel bandwidth segments, the actual number of channel bandwidth segments (and their corresponding reference points) of the above and below described implementations may be more than two channel bandwidth segments.

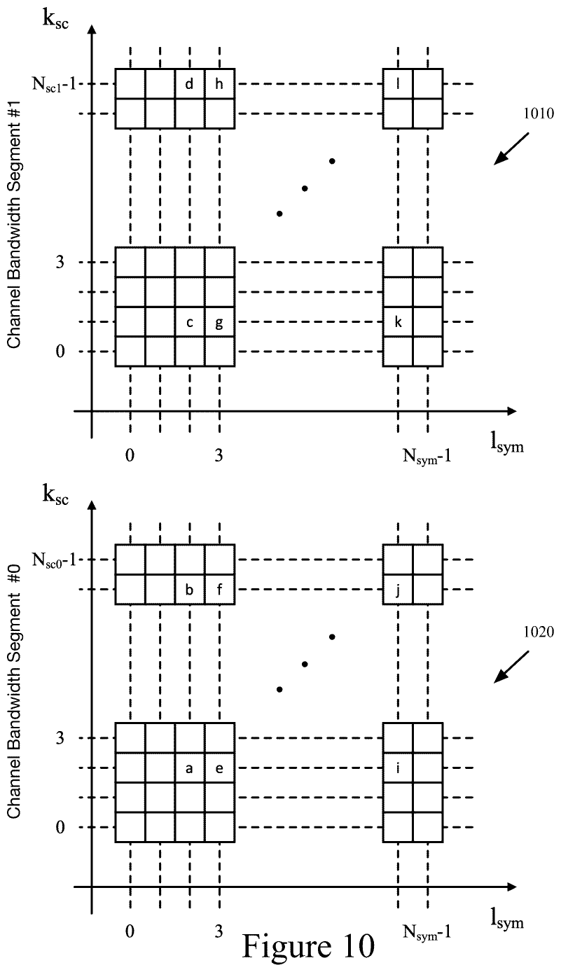

FIG. 10 is a diagram illustrating PDSCH mapping in two resource grids 1010 and 1020, where each resource grid is associated with a channel bandwidth segment, according to an example implementation of the present disclosure. In FIG. 10, the horizontal axis represents the OFDM symbol index l_{sym} and the vertical axis represents the subcarrier index k_{sc}. For simplicity of the description, in FIG. 10, the number of OFDM symbols N_{sym} in the two resource grids are the same. The number of subcarriers for channel bandwidth segment #0 is N_{SC0} and the number of subcarriers for channel bandwidth segment #1 is N_{SC1}.

For a single PDSCH, the BS may assign one set of frequency resources in channel bandwidth segment #0 and another set of frequency resources in channel bandwidth segment #1. In the example shown in FIG. 10, subcarriers from k_{sc}=2 to k_{sc}=N_{sc0}−2 in channel bandwidth segment #0 and subcarriers from k_{sc}=1 to k_{sc}=N_{sc1}−1 in channel bandwidth segment #1 are assigned. The time resource allocation assumes from l_{sym}=2 to l_{sym}=N_{sym}−2. In this example, if frequency-first RE mapping is applied for the PDSCH, modulation symbol sequences are mapped from resource element #a to #b in channel bandwidth segment #0, then resource element #c to #d in channel bandwidth segment #1, then resource element #e to #f in channel bandwidth segment #0, then resource element #g to #h in channel bandwidth segment #1, then resource element #i to #j in channel bandwidth segment #0, and then resource element #k to #1 in channel bandwidth segment #1. In that way, a single PDSCH may be mapped to the two channel bandwidth segments and may, therefore, exploit frequency diversity across non-contiguous frequency bandwidths.

In terms of frequency domain resource assignment, resource block (RB) may be used as the minimum unit. The RBs may be defined as a set of resource elements in the contiguous subcarriers in one OFDM symbol. Alternatively, the RBs may be defined as a set of contiguous subcarriers. The number of subcarriers in each RB, for example, and without limitations, may be 12.

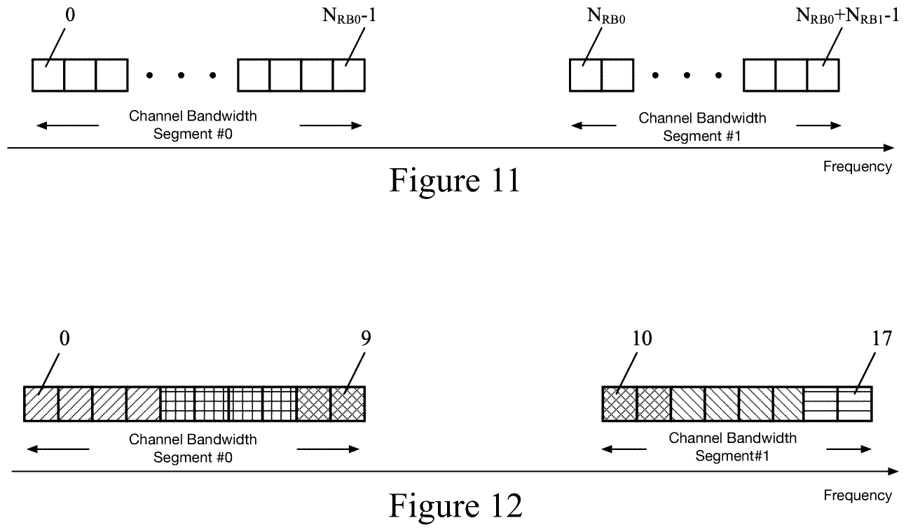

FIG. 11 is a diagram illustrating an example of RB indexing, according to an example implementation of the present disclosure. The horizontal domain represents frequency. In FIG. 11, RB indexing is done in the frequency order. As shown in FIG. 11, the RB index starts from 0 in the lowest frequency of channel bandwidth segment #0 and is mapped in an ascending order. In a case where channel bandwidth segment #0 includes N_{RB0} RBs, the RB index with the highest frequency is N_{RB0}−1. Next, in channel bandwidth segment #1, the RB index starts from N_{RB0} in the lowest frequency of channel bandwidth segment #1 and is mapped in the ascending order. In a case where channel bandwidth segment #1 includes N_{RB1} RBs, the RB index with the highest frequency is N_{RB0}+N_{RB1}−1.

To indicate frequency domain resources, Resource Block Group (RBG) level assignment may be used in some implementations. An RBG may include one or more RBs. For example, if the serving cell forms X RBGs, then an X-bits bitmap may indicate the frequency domain assignment for a physical channel.

FIG. 12 is a diagram illustrating an example of RBG mapping across multiple channel bandwidth segments, according to an example implementation of the present disclosure. In FIG. 12, four contiguous RBs form an RBG. The two RBs at the higher edge of channel bandwidth segment #0 and the two RBs in the lower edge of channel bandwidth segment #1 form an RBG. The remaining two RBs at the higher edge of channel bandwidth segment #1 form an RBG, which may be referred to as a partial RBG.

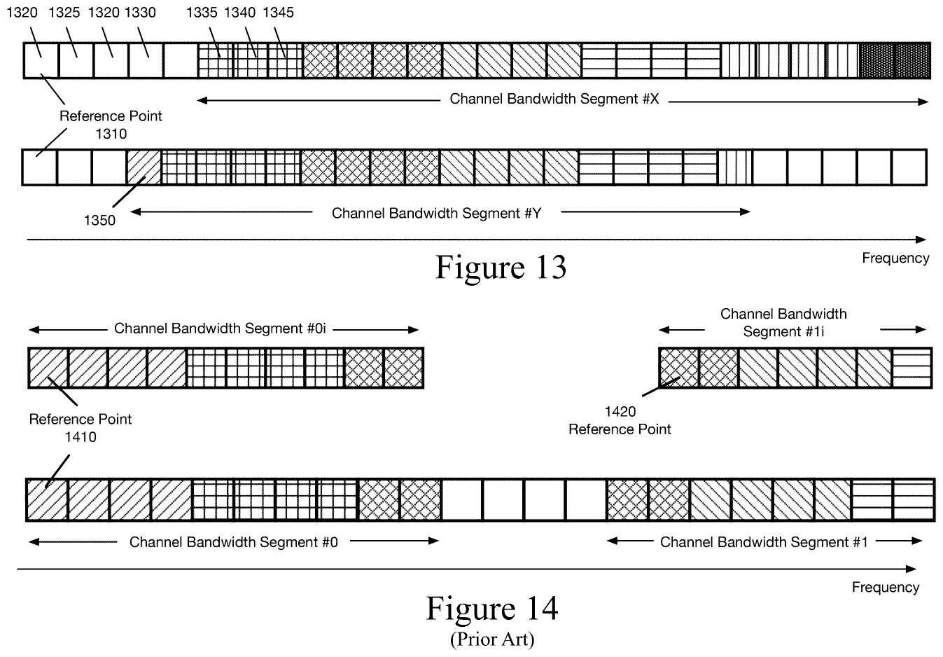

In defining the RBGs, reference points may be introduced to align the RBG grids, for example, to be used by different UEs with different channel bandwidth segments. FIG. 13 is a diagram illustrating an example of RBG mapping using a reference point, according to an example implementation of the present disclosure. In FIG. 13, the lowest resource block in each channel bandwidth segment #0 and #1 represents the reference point 1310. Irrespective of the location and size of the UE's channel bandwidth segment, the RBG mapping may start from the reference point 1310. A reference point, in some embodiments, may be an identifier for a specific subcarrier. For example, a reference point may be similar to Point 300 (also referred to as Point A), described above with reference to FIG. 3.

In channel bandwidth segment #X for UE X, the first 4 RBs starting from the reference point do not form an RBG since they are outside of the channel bandwidth segment #X. On the other hand, in the next 4 RBs, 3 RBs 1335-1345 at the higher end form a partial RBG. Similarly, in channel bandwidth segment #Y for UE Y, 1 RB 1350 at the higher end of the first 4 RBs starting from the reference point forms a partial RBG. In this way, irrespective of the size and location of a UE's channel bandwidth segment, the RBG grid may be aligned.

The RBGs may be calculated starting from the RB index of channel bandwidth segment N_{CBW}^{start}, which is an RB index counted from the reference point to the RB at the lowest edge in the channel bandwidth segment. The first RBG, which is at the lowest edge of the channel bandwidth segment, may form the first

$$P - mod ( {N}_{CBW}^{start} , P )$$

RBS. The last RBG, which is at the highest edge of the channel bandwidth segment, may form the last mod

$$( {N}_{CBW}^{start} + {N}_{CBW}^{size} , P )$$

### RBs if mod

$$( {N}_{CBW}^{start} + {N}_{CBW}^{size} , P ) > 0 ,$$

and may form the last P RBs, otherwise. Here,

$${N}_{CBW}^{size}$$

represents the number of RBs in the channel bandwidth segment and P is the nominal RBG size.

Two different RB index definitions may be used. One is RB indexing starting from the reference point, which is used to define the starting RB of the channel bandwidth segment. This RB index may be referred to as a common RB index. The other RB indexing is starting from the RB at the lowest edge of the channel bandwidth segment, which may be referred to as physical RB index.

### Problem 1a: How to Define RBGs Across Multiple Channel Bandwidth Segments In an Efficient Manner

FIG. 14 is a diagram illustrating an example of multiple channel bandwidth segments coexisting with incumbent services, according to prior art. Channel bandwidth segment #0i may be for an incumbent service (e.g., 5G NR) and channel bandwidth segment #1i may be for another incumbent service (e.g., LTE). In a case where the incumbent services have similar radio structures, such as OFDM, with the same subcarrier spacing, aligning frequency domain resource assignment may be beneficial.

However, as shown in FIG. 14, if the RBG grid for channel bandwidth segment #0 is defined differently (e.g., with an OFDM having a different subcarrier spacing) from the RBG grid for channel bandwidth segment #0i, it may cause inefficient resource assignment. Likewise, if the RBG grid for channel bandwidth segment #1 is defined differently from the RBG grid for channel bandwidth segment #1i, it may cause inefficient resource assignment. In the example of FIG. 14, the problem to be solved is the inefficient frequency resource assignment in terms of RBGs when multiple channel bandwidth segments with incumbent services coexist.

### Problem 1b: How to Define PRGs Across Multiple Channel Bandwidth Segments In an Efficient Manner

Precoding Resource Group (PRG) is defined such that the UE may assume the same precoder applied to the resource elements within a PRG. This assumption is useful for efficient channel estimation in the UE side. The same problems happen for the PRGs as the RBGs. The problem described in FIG. 14 for RBGs may also happen in PRGs.

For example, if the PRG grid for channel bandwidth segment #0 is defined differently (e.g., with an OFDM with a different subcarrier spacing) from the PRG grid for channel bandwidth segment #0i, it may cause inefficient resource assignment. Likewise, if the PRG grid for channel bandwidth segment #1 is defined differently from the PRG grid for channel bandwidth segment #1i, it may cause inefficient resource assignment. The problem to be solved is the inefficient frequency resource assignment in terms of PRGs when multiple channel bandwidth segments coexist with incumbent services.

### Problem 1c: How to Define VRB Bundles Across Multiple Channel Bandwidth Segments in an Efficient Manner

Frequency domain resource assignment may be achieved by indicating the start and length of the scheduled RBs, which may be beneficial to reduce the size of the indication. An example coding may include Resource Indication Value (RIV), which encodes the start RB RBₛₜₐᵣₜ and the length L_{RBs} of the scheduled RBs using Eq. (1) and (2).

$$RIV = {N}_{CBW}^{size} ( {L}_{RBs} - 1 ) + {RB}_{start} \qquad ( 1 )$$

$$RIV = {N}_{CBW}^{size} ( {N}_{CBW}^{size} - {L}_{RBs} + 1 ) + {N}_{CBW}^{size} - 1 - {RB}_{start} \qquad ( 2 )$$

In RIV encoding, Eq. (1) may be applied if

$$( {L}_{RBs} - 1 ) \leq floor ( {N}_{CBW}^{size} / 2 )$$

and Eq. (2) may be applied if

$$( {L}_{RBs} - 1 ) > floor ( {N}_{CBW}^{size} / 2 ) .$$

Here, L_{RBs} may not exceed

$${N}_{CBW}^{size} - {RB}_{start} .$$

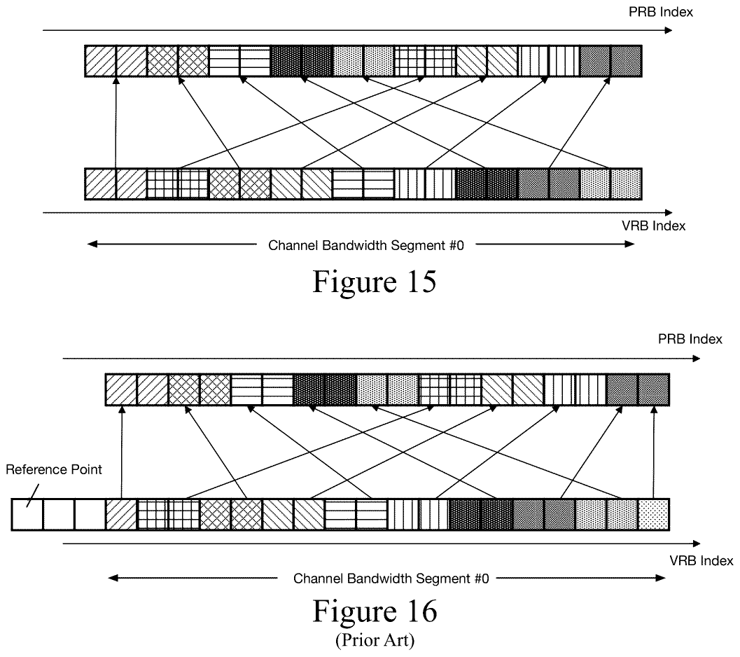

RIV achieves scheduling for contiguous RBs. On the other hand, distributed RB scheduling is possible by introducing interleaving of RBs. FIG. 15 is a diagram illustrating an example of distributed RB scheduling based on interleaving, according to an example implementation of the present disclosure. In FIG. 15, Virtual Resource Block (VRB) domain is introduced. VRBs are virtual concept of RB allocation. As shown in the figure, VRBs may be mapped to PRBs in interleaved manner. If the RIV indicates RBₛₜₐᵣₜ and L_{RBs} of the scheduled VRBs, the final PRB allocation will distribute in the frequency domain.

For example, interleaved VRB-to-PRB mapping may be formulated by f(j)=rC+c, where j is the VRB bundle index and f(j) is the PRB bundle index associated with the VRB bundle index j. Here, j=cR+r, r=0, 1, . . . , R−1, c=0, 1, . . . C−1, R=2, C=floor(N_{bundle}/2). N_{bundle} represents the unit size of the interleaver. In the example of FIG. 15, N_{bundle}=2. If j=N_{bundle}−1, VRB bundle j may be mapped to PRB bundle j. If j≠N_{bundle}−1, VRB bundle j may be mapped to PRB bundle f(j).

FIG. 16 is a diagram illustrating an example of defining the interleaver unit using a reference point, according to prior art. The interleaver units may be calculated if the starting RB index of channel bandwidth segment

$${N}_{CBW}^{size}$$

which is an RD index counted from the reference point to the RB at the lowest edge in the channel bandwidth segment. The first interleaver unit, which is at the lowest edge of the channel bandwidth segment, may form the first

$${N}_{bundle} - mod ( {N}_{CBW}^{start} , {N}_{bundle} )$$

RBs. The last interleaver unit, which is at the highest edge of the channel bandwidth segment, may form the last mod

$$( {N}_{CBW}^{start} + {N}_{CBW}^{size} , {N}_{bundle} )$$

### RBs if mod

$$( {N}_{CBW}^{start} + {N}_{CBW}^{size} , {N}_{bundle} ) > 0$$

and may form the last N_{bundle} RBs otherwise. Here,

$${N}_{CBW}^{size}$$

represents the number of RBs in the channel bandwidth segment and N_{bundle} is the unit size of the interleaver.

With reference to FIG. 16, the problem to be solved is inefficient frequency resource assignment in terms of interleaver units when multiple channel bandwidth segments coexist with incumbent services. In contrast to FIG. 15 where the PRB and VRB bundle grids coincide, in the example shown in in FIG. 16, the grids are not aligned due to the existence of the reference point.

### Problem 2: How to Define VRB-to-PRB Mapping Across Multiple Channel Bandwidth Segments in an Efficient Manner

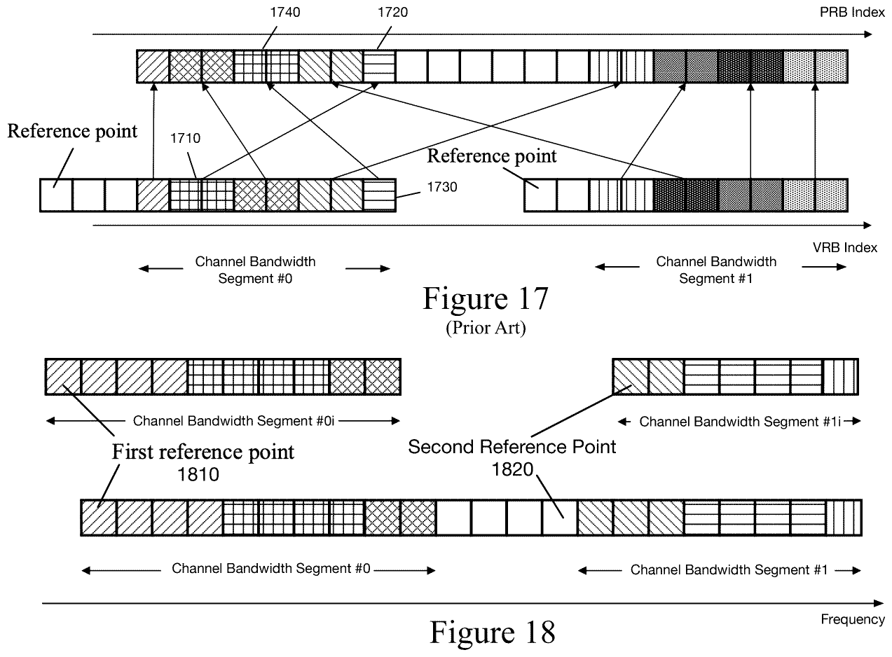

FIG. 17 is a diagram illustrating an example of VRB-to-PRB mapping across multiple channel bandwidth segments, according to prior art. The mapping shown in FIG. 17 does not work since the interleaver unit size does not align in some parts. For example, VRB bundle index j=1 1710 maps to PRB bundle index j=4 1720 which is a partial bundle. In another example, VRB bundle index j=4 1730 which is a partial bundle maps to PRB bundle j=2 1740 which is full bundle. With reference to FIG. 17, the problem to be solved is inefficient frequency resource assignment in terms of VRB-to-PRB mapping when multiple channel bandwidth segments coexist with incumbent services.

In the following, solutions are presented assuming a serving cell including two downlink channel bandwidth segments, namely channel bandwidth segment #0 and channel bandwidth segment #1. However, the solutions are also equally applicable to more than two downlink channel segments. The solutions are also equally applicable to two or more uplink channel bandwidth segments.

A serving cell may include two or more downlink channel bandwidth segments. The two downlink channel bandwidth segments may be separate from each other in the frequency domain. Each downlink channel bandwidth segment may include a number of resource blocks.

Information on the size and location of each downlink channel bandwidth segment may be provided by the base station, for example, via RRC signaling, SIB, PBCH, MAC CE, or DCI.

### Solutions to Problem 1a

FIG. 18 is a diagram illustrating an example of RBG mapping for multiple channel bandwidth segments using multiple reference points, according to an example implementation of the present disclosure. In the example of FIG. 18, the first reference point 1810 may be used to determine RBGs within channel bandwidth segment #0 and the second reference point 1820 may be used to determine RBGs within channel bandwidth segment #1.

The RBGs in channel bandwidth segment #0 may be calculated starting from the RB index of channel bandwidth segment #0

$${N}_{CBW 0}^{start} ,$$

which is an RD index counted from the first reference point to the RB at the lowest edge in the channel bandwidth segment #0. In FIG. 18,

$${N}_{CBW 0}^{start} = 0.$$

The first RBG, which is at the lowest edge of channel bandwidth segment #0, may form the first

$${P}_{0} - mod ( {N}_{CBW 0}^{start} , {P}_{0} )$$

RBs. The last RBG, which is at the highest edge of channel bandwidth segment #0, may form the last mod

$$( {N}_{CBW 0}^{start} + {N}_{CBW 0}^{s i z e} , {P}_{0} )$$

### RBs if mod

$$( {N}_{CBW 0}^{start} + {N}_{CBW0}^{s i z e} , {P}_{0} ) > 0 ,$$

and may form the last P₀ RBs otherwise. Here

$${N}_{CBW 0}^{s i z e}$$

represents the number of RBs in channel bandwidth segment #0 and P₀ is the nominal RBG size of channel bandwidth segment #0.

The RBGs in channel bandwidth segment #1 may be calculated starting from the RB index of channel bandwidth segment #1

$${N}_{CBW 1}^{start} ,$$

which is an KB index counted from the second reference point to the RB at the lowest edge in the channel bandwidth segment #1. In FIG. 18,

$${N}_{CBW 1}^{start} = 1 .$$

The first RBG, which is at the lowest edge of the channel bandwidth segment #1, may form the first

$${P}_{1} - mod ( {N}_{CBW 1}^{start} , {P}_{1} )$$

RBs. The last RBG, which is at the highest edge of channel bandwidth segment #1, may form the last mod

$$( {N}_{CBW 1}^{start} + {N}_{CBW 1}^{s i z e} , {P}_{1} )$$

### RBs if mod

$$( {N}_{CBW 1}^{start} + {N}_{CBW 1}^{s i z e} , {P}_{1} ) > 0 ,$$

and may form the last P₁ RBs otherwise. Here,

$${N}_{CBW 1}^{s i z e}$$

represents the number of RBs in channel bandwidth segment #1 and P₁ is the nominal RBG size of channel bandwidth segment #1. In the example of FIG. 18,

$${N}_{CBW 0}^{start} = 0 , {N}_{CBW 0}^{s i z e} = 10 , {N}_{CBW 1}^{start} = 1 , {N}_{CBW 1}^{s i z e} = 8 ,$$

P₀=4, and P₁=4.

As shown in the implementation of FIG. 18, in a physical channel transmission across multiple channel bandwidth segments which are separated from each other, the RBG grids for multiple channel bandwidth segments may be defined. A separate reference point may be provided for each channel bandwidth segment. The RBG grid for each bandwidth segment may then be determined based on the corresponding reference point.

### Solutions to Problem 1b

FIG. 18 is also applicable to mapping PRGs for channel bandwidth segment #0 and channel bandwidth segment #1 using two reference points 1810 and 1820. The PRGs in channel bandwidth segment #0 may be calculated starting from the RB index of channel bandwidth segment #0

$${N}_{CBW 0}^{start} ,$$

which is an KD index counted from the first reference point 1810 to the RB at the lowest edge in the channel bandwidth segment #0. The first PRG, which is at the lowest edge of channel bandwidth segment #0, may form the first

$${P}_{PRG 0} - mod ( {N}_{CBW 0}^{start} , {P}_{PRG 0} )$$

RBs. The last PRG, which is at the highest edge of channel bandwidth segment #0, may form the last mod

$$( {N}_{CBW 0}^{start} + {N}_{CBW 0}^{s i z e} , {P}_{PRG 0} ) RBs if mod ( {N}_{CBW 0}^{start} + {N}_{CBW 0}^{s i z e} , {P}_{PRG 0} ) > 0 ,$$

and may form the last mod P_{PRG0} RBs otherwise. Here,

$${N}_{CBW 0}^{s i z e}$$

represent the number of RBs in channel bandwidth segment #0 and P_{PRG0} is the nominal PRG size of channel bandwidth segment #0.

The PRGs in channel bandwidth segment #1 may be calculated starting from the RB index of channel bandwidth segment #1

$${N}_{CBW 1}^{start} ,$$

which is an RB index counted from the second reference point 8120 to B at the lowest edge in the channel bandwidth segment #1. The first PRG, which is at the lowest edge of the channel bandwidth segment #1, may form the first P₁-mod

$$( {N}_{CBW 1}^{start} , {P}_{PRG 1} )$$

RBs. The last PRG, which is at the highest edge of channel bandwidth segment #1, may form the last mod

$$( {N}_{CBW 1}^{start} + {N}_{CBW 1}^{size} , {P}_{PRG 1} )$$

### RBs if mod

$$( {N}_{CBW 1}^{start} + {N}_{CBW 1}^{size} , {P}_{PRG 1} ) > 0 ,$$

and may form the last P_{PRG1} RBs otherwise. Here,

$${N}_{CBW 1}^{size}$$

represents the number of RBs in channel bandwidth segment #1 and P_{PRG1} is the nominal PRG size of channel bandwidth segment #1.

As shown in the implementation of FIG. 18, in a physical channel transmission across multiple channel bandwidth segments which are separated from each other, the PRG grids for the channel bandwidth segments may be defined. A separate reference point may be provided for each channel bandwidth segment. The PRG grid for each bandwidth segment may then be determined based on the corresponding reference point.

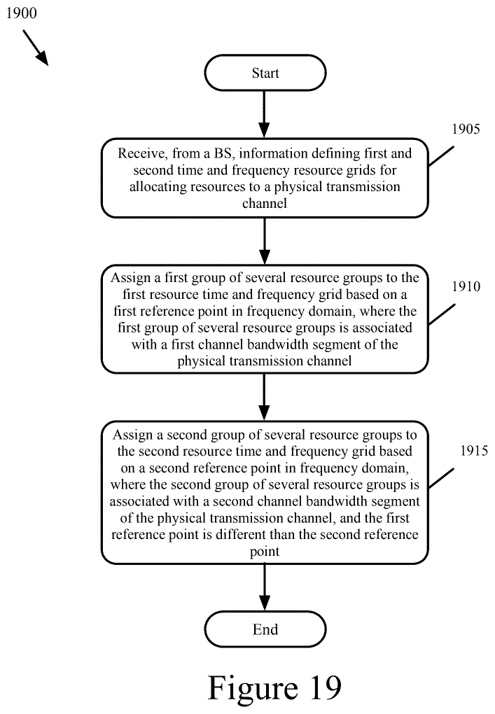

FIG. 19 is a flowchart illustrating an example method/process 1900 performed by a UE for assigning resource groups to multiple channel bandwidth segments of a physical transmission channel by using multiple different reference points, according to an example implementation of the present disclosure. With reference to FIG. 19, the process 1900 may be performed by at least one processor of a UE 101A-101C, shown in FIG. 1.

The process 1900 may receive (at block 1905), from a BS, information defining first and second time and frequency resource grids for allocating resources to a physical transmission channel. For example, the process 1900 may receive information defining the time and frequency resource grids 1010 and 1020, described above with reference to FIG. 10. The physical transmission channel may be a PDSCH, a PUSCH, a PDCCH, or a PUCCH.

The process 1900 may assign (at block 1910) a first group of several resource groups to the first resource time and frequency grid based on a first reference point in frequency domain. The first group of several resource groups may be associated with a first channel bandwidth segment of the physical transmission channel. The first and second channel bandwidth segments, in some embodiments, may be non-contiguous.

The process 1900 may assign (at block 1915) a second group of several resource groups to the second resource time and frequency grid based on a second reference point in frequency domain. The second group of several resource groups may be associated with a second channel bandwidth segment of the physical transmission channel. The first reference point may be different than the second reference point. The process 1900 may then end.

The resource groups in the first and second groups of resource groups, in some embodiments, may be resource RBGs, and each RBG may include one or more resource blocks. The resource groups in the first and second groups of resource groups, in some embodiments, may be PRGs, and each PRG may include several resource blocks sharing the same precoding matrix during MIMO transmission. The process 1900, in some embodiments, may receive, from the BS, the first and second reference points via an RRC signaling, a SIB, a PBCH, a MIB, a DCI, or a MAC CE.

The process 1900, in some embodiments, may contiguously assign the first group of resource groups starting at a first resource group index counted from the first reference point. The number of resources in the first resource group in the first group of resource groups may include a nominal resource group size minus the modulo of the first resource group index and the nominal resource group size of the first channel bandwidth segment. The number of resources in the last resource group in the first group of resource groups may include the modulo of the first resource group index plus the number of resources in the first channel bandwidth segment and the nominal resource group size of the first channel bandwidth segment.

The process 1900, in some embodiments, may contiguously assign the second group of resource groups starting at a second resource group index counted from the second reference point. The number of resources in the first resource group in the second group of resource groups may include a nominal resource group size of the second channel bandwidth segment minus the modulo of the second resource group index and the nominal resource group size of the second channel bandwidth segment. The number of resources in the last resource group in the second group of resource groups may include the modulo of the second resource group index plus the number of resources in the second channel bandwidth segment and the nominal resource group size of the second channel bandwidth segment.

### Solutions to Problem 1c

The RB bundles in channel bandwidth segment #0 may be calculated starting from the RB index of channel bandwidth segment #0

$${N}_{CBW 0}^{start} ,$$

which is an KB index counted from the first reference point to the RB at the lowest edge in the channel bandwidth segment #0. The first RB bundle, which is at the lowest edge of channel bandwidth segment #0, may form the first

$${N}_{bundle 0} - mod ( {N}_{CBW 0}^{start} , {N}_{bundle 0} )$$

RBs. The last RB bundle, which is at the highest edge of channel bandwidth segment #0, may form the last mod

$$( {N}_{CBW 0}^{start} + {N}_{CBW 0}^{size} , {N}_{bundle 0} )$$

### RBs if mod

$$( {N}_{CBW 0}^{start} + {N}_{CBW 0}^{size} , {N}_{bundle 0} ) > 0 ,$$

and may form the last N_{bundle0} RBs otherwise. Here,

$${N}_{CBW 0}^{size}$$

represents the number RBs in channel bandwidth segment #0 and N_{bundle0} is the nominal RB bundle size of channel bandwidth segment #0.

The RB bundles in channel bandwidth segment #1 may be calculated starting from the RB index of channel bandwidth segment #1

$${N}_{CBW 1}^{start} ,$$

which is an KB index counted from the second reference point to the RB at the lowest edge in the channel bandwidth segment #1. The first RB bundle, which is at the lowest edge of the channel bandwidth segment #1, may form the first

$${N}_{bundle 1} - mod ( {N}_{CBW 1}^{start} , {N}_{bundle 1} )$$

RBs. The last RB bundle, which is at the highest edge of channel bandwidth segment #1, may form the last mod

$$( {N}_{CBW 1}^{start} + {N}_{CBW 1}^{size} , {N}_{bundle 1} )$$

### RBs if mod

$$( {N}_{CBW 1}^{start} + {N}_{CBW 1}^{size} , {N}_{bundle 1} ) > 0 ,$$

and may form the last N_{bundle1} RBs otherwise. Here,

$${N}_{CBW 1}^{size}$$

represents the number of RBs in channel bandwidth segment #1 and N_{bundle1} is the nominal RB bundle size of channel bandwidth segment #1.

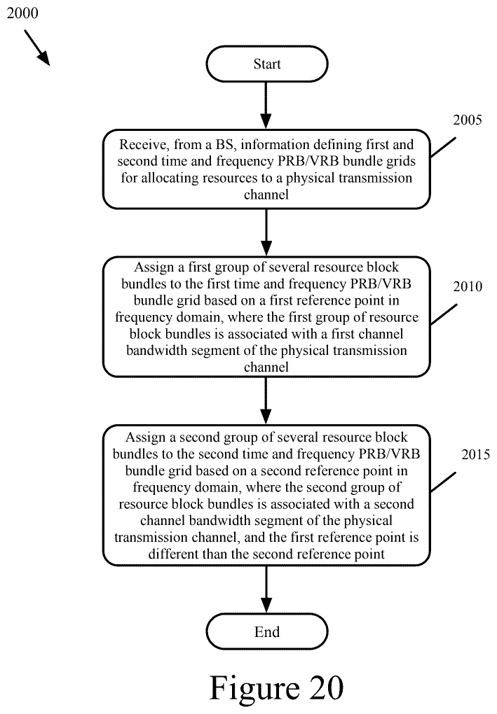

FIG. 20 is a flowchart illustrating an example method/process 2000 performed by a UE for defining PRB/VRB bundles for two channel bandwidth segments of a physical transmission channel by using two different reference points, according to an example implementation of the present disclosure. With reference to FIG. 20, the process 2000 may be performed by at least one processor of a UE 101A-101C, shown in FIG. 1.

The process 2000 may receive (at block 2005), from a BS, information defining first and second time and frequency PRB/VRB bundle grids for allocating resources to a physical transmission channel. For example, the process 1900 may receive information defining the time and frequency resource grids 1010 and 1020, described above with reference to FIG. 10. The physical transmission channel may be a PDSCH, a PUSCH, a PDCCH, or a PUCCH.

The process 2000 may assign (at block 2010) a first group of several resource block bundles to the first time and frequency PRB/VRB bundle grid based on a first reference point in frequency domain. The first group of resource block bundles may be associated with a first channel bandwidth segment of the physical transmission channel

The process 2000 may assign (at block 2015) a second group of several resource block bundles to the second time and frequency PRB/VRB bundle grid based on a second reference point in frequency domain. The second group of resource block bundles may be associated with a second channel bandwidth segment of the physical transmission channel. The first reference point may be different than the second reference point. The process 2000 may then end.

The process 2000, in some embodiments, may receive, from the BS, the first and second reference points via an RRC signaling, a SIB, a PBCH, a MIB, or a DCI. In some embodiments, the first group of resource block bundles may be assigned by indicating the starting point of the first group of resource block bundles from the first reference point and the length of the first group of resource block bundles. In some embodiments, the second group of resource block bundles may be assigned by indicating the starting point of the second group of resource block bundles from the second reference point and the length of the second group of resource block bundles.

The process 2000, in some embodiments, may assign the first group of resource block bundles, in an interleaving manner, starting at the first resource block index counted from the first reference point. The number of resource block bundles in the first resource block bundle in the first group of resource block bundles may include a nominal resource block bundle size minus the modulo of the first resource block index and the nominal resource block bundle size of the first channel bandwidth segment.

In a case that the modulo of the first resource block index plus the number of resource blocks in the first channel bandwidth segment and the nominal resource block bundle size of the first channel bandwidth segment is greater than zero, the number of resource block bundles in the last resource block bundle in the first group of resource block bundles may include the modulo of the first resource block index plus the number of resource blocks in the first channel bandwidth segment and the nominal resource block bundle size of the first channel bandwidth segment. In a case that the modulo of the first resource block index plus the number of resource blocks in the first channel bandwidth segment and the nominal resource block bundle size of the first channel bandwidth segment is not greater than zero, the number of resource block bundles in the last resource block bundle in the first group of resource block bundles may include the nominal resource block bundle size of the first channel bandwidth segment.

The process 2000, in some embodiments, may assign the second group of resource block bundles, in an interleaving manner, starting at a second resource block index counted from the second reference point. The number of resource block bundles in the first resource block bundle in the second group of resource block bundles may include a nominal resource block bundle size minus the modulo of the second resource block index and the nominal resource block bundle size of the second channel bandwidth segment.

In a case that the modulo of the second resource block index plus a number of resource blocks in the second channel bandwidth segment and the nominal resource block bundle size of the second channel bandwidth segment is greater than zero, the number of resource block bundles in the last resource block bundle in the second group of resource block bundles may include the modulo of the second resource block index plus the number of resource blocks in the second channel bandwidth segment and the nominal resource block bundle size of the second channel bandwidth segment. In a case that the modulo of the second resource block index plus the number of resource blocks in the second channel bandwidth segment and the nominal resource block bundle size of the second channel bandwidth segment is not greater than zero, the number of resource block bundles in the last resource block bundle in the second group of resource block bundles may be the nominal resource block bundle size of the second channel bandwidth segment.

In the implementation of FIG. 20, in a physical channel transmission across multiple channel bandwidth segments which are separated from each other, the PRB/VRB bundle grids for the multiple channel bandwidth segments may be defined. A separate reference point may be provided for each channel bandwidth segment. The PRB/VRB bundle grid for each bandwidth segment may then be determined based on the corresponding reference point.

### Solutions to Problem 2

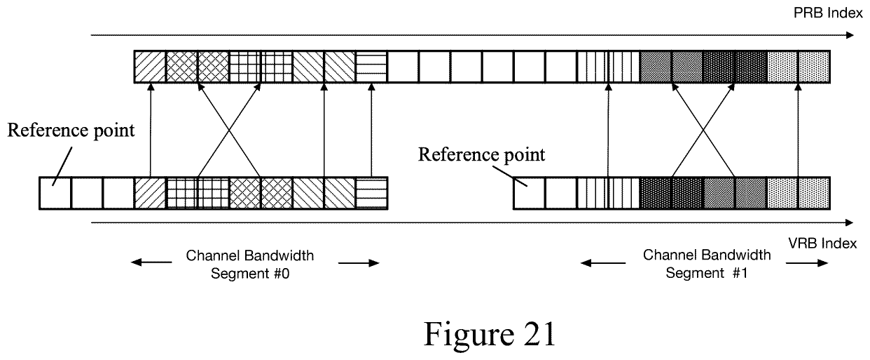

FIG. 21 is a diagram illustrating an example of VRB-to-PRB mapping for multiple channel bandwidth segments, according to an example implementation of the present disclosure. In FIG. 21, the VRB-to-PRB mapping may be performed per channel bandwidth segment. For channel bandwidth segment #0, the VRB-to-PRB mapping may be performed assuming N_{bundle} is the number of RB bundles in channel bandwidth segment #0. For channel bandwidth segment #1, the VRB-to-PRB mapping may be performed assuming N_{bundle} is the number of RB bundles in channel bandwidth segment #1.

In the implementation of FIG. 21, in a physical channel transmission across multiple channel bandwidth segments which are separated from each other, the PRB/VRB bundle grids for the channel bandwidth segments may be defined. The PRB-to-VRB mapping may then be performed independently for each channel bandwidth segment.

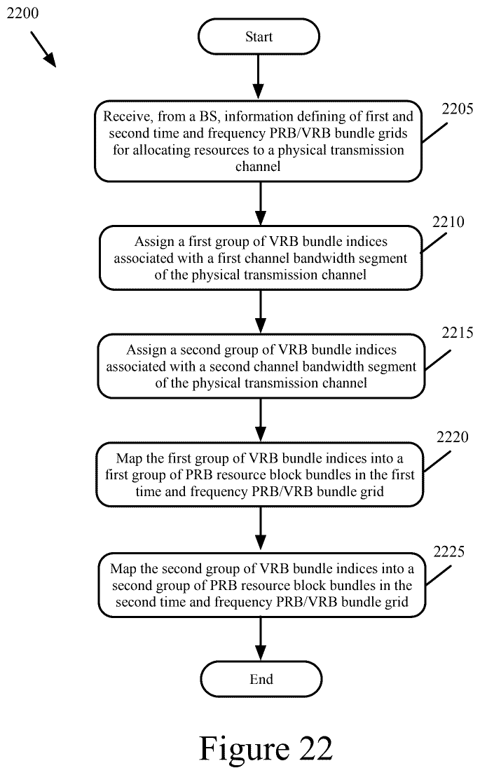

FIG. 22 is a flowchart illustrating an example method/process 2200 performed by a UE for mapping VRB bundles to PRB bundles for multiple channel bandwidths of a physical transmission channel, according to an example implementation of the present disclosure. With reference to FIG. 22, the process 2200 may be performed by at least one processor of a UE 101A-101C, shown in FIG. 1.

The process 2200 may receive (at block 2205), from a BS, information defining first and second time and frequency PRB/VRB bundle grids for allocating resources to a physical transmission channel. The physical transmission channel may be a PDSCH, a PUSCH, a PDCCH, or a PUCCH. The process 2200, in some embodiments, may receive, from the BS, the information defining the first and second time and frequency PRB/VRB bundle grids via an RRC signaling, a SIB, a PBCH, a MIB, a DCI, or a MAC CE.

The process 2200 may assign (at block 2210) a first group of VRB bundle indices associated with a first channel bandwidth segment of the physical transmission channel. The process 2200 may assign (at block 2215) a second group of VRB bundle indices associated with a second channel bandwidth segment of the physical transmission channel. The first and second channel bandwidth segments, in some embodiments, may be non-contiguous.

The process 2200 may map (at block 2220) the first group of VRB bundle indices into a first group of PRB resource block bundles in the first time and frequency PRB/VRB bundle grid

The process 2200 may map (at block 2225) the second group of VRB bundle indices into a second group of PRB resource block bundles in the second time and frequency PRB/VRB bundle grid. The process 2200 may then end.

The first group of PRB resource block bundles, in some embodiments, may not be interleaved with the second group of PRB resource block bundles. The first group of VRB bundle indices, in some embodiments, may be mapped into the first group of PRB resource block bundles by using a first interleaver, and the second group of VRB bundle indices may be mapped into the second group of PRB resource block bundles using a second interleaver. The first interleaver, in some embodiments, may use a first nominal bundle size that defines the number of PRBs in each PRB resource block bundle in the first group of PRB resource block bundles, and the second interleaver may use a second nominal bundle size that defines the number of PRBs in each PRB resource block bundle in the second group of PRB resource block bundles. In some embodiments, the first and second group of VRB bundle indices may be separately mapped into the first and second group of PRB resource block bundles, respectively, using the same interleaver.

The process 2200, in some embodiments, may transmit, to the BS, an uplink message in the first channel bandwidth segment using the first group of PRB resource block bundles and may transmit, to the BS, an uplink message in the second channel bandwidth segment using the second group of PRB resource block bundles. The process 2200, in some embodiments, may simultaneously transmit, to the BS, an uplink message in the first channel bandwidth segment using the first group of PRB resource block bundles and in the second channel bandwidth segment using the second group of PRB resource block bundles in TDD.

The process 2200, in some embodiments, may receive, from the BS, a downlink message in the first channel bandwidth segment using the first group of PRB resource block bundles, and may receive, from the BS, a downlink message in the second channel bandwidth segment using the second group of PRB resource block bundles. The process 2200, in some embodiments, may simultaneously receive, from the BS, a downlink message in the first channel bandwidth segment using the first group of PRB resource block bundles and in the second channel bandwidth segment using the second group of PRB resource block bundles in TDD.

The process 2200, in some embodiments, may assign the first group of PRB resource block bundles, in an interleaving manner, starting at a first resource block index counted from a first reference point. The number of resource block bundles in the first PRB resource block bundle in the first group of PRB resource block bundles may include a nominal resource block bundle size minus the modulo of the first resource block index and the nominal resource block bundle size of the first channel bandwidth segment. In a case that the modulo of the first resource block index plus the number of resource blocks in the first channel bandwidth segment and the nominal resource block bundle size of the first channel bandwidth segment is greater than zero, the number of resource block bundles in the last PRB resource block bundle in the first group of PRB resource block bundles may include the modulo of the first resource block index plus the number of resource blocks in the first channel bandwidth segment and the nominal resource block bundle size of the first channel bandwidth segment. In a case that the modulo of the first resource block index plus the number of resource blocks in the first channel bandwidth segment and the nominal resource block bundle size of the first channel bandwidth segment is not greater than zero, the number of resource block bundles in the last PRB resource block bundle in the first group of PRB resource block bundles may include the nominal resource block bundle size of the first channel bandwidth segment.

The process 2200, in some embodiments, may assign the second group of PRB resource block bundles, in an interleaving manner, starting at a second resource block index counted from a second reference point. The number of resource block bundles in the first PRB resource block bundle in the second group of PRB resource block bundles may include the nominal resource block bundle size minus the modulo of the second resource group index and the nominal resource block bundle size of the second channel bandwidth segment. In a case that the modulo of the second resource block index plus the number of resource blocks in the second channel bandwidth segment and the nominal resource block bundle size of the second channel bandwidth segment is greater than zero, the number of resource block bundles in the last PRB resource block bundle in the second group of PRB resource block bundles may include the modulo of the second resource block bundle index plus the number of resource blocks in the second channel bandwidth segment and the nominal resource block bundle size of the second channel bandwidth segment. In a case that the modulo of the second resource block index plus the number of resource blocks in the second channel bandwidth segment and the nominal resource block bundle size of the second channel bandwidth is not greater than zero, the number of resource block bundles in the last PRB resource block bundle in the second group of PRB resource block bundles may include the nominal resource block bundle size of the second channel bandwidth segment.

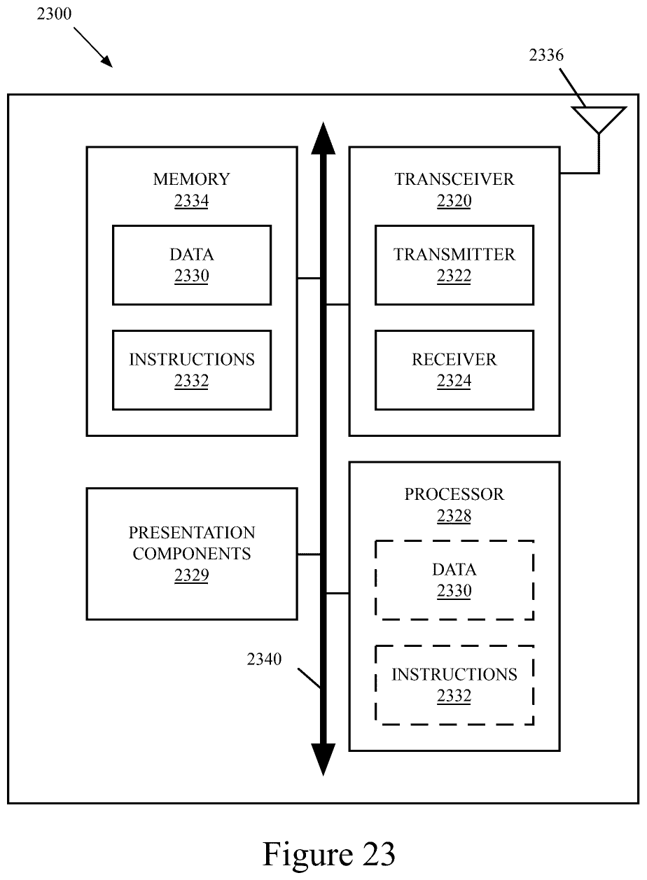

FIG. 23 is a block diagram illustrating a node 2300 for wireless communication, according to an example implementation of the present disclosure. As illustrated in FIG. 23, a node 2300 may include a transceiver 2320, a processor 2328, a memory 2334, one or more presentation components 2329, and at least one antenna 2336. The node 2300 may also include a radio frequency (RF) spectrum band module, a BS communications module, a network communications module, and a system communications management module, Input/Output (I/O) ports, I/O components, and a power supply (not illustrated in FIG. 23).

Each of the components may directly or indirectly communicate with each other over one or more buses 2340. The node 2300 may be a UE or a BS that performs various functions disclosed with reference to FIGS. 1 through 22.

The transceiver 2320 has a transmitter 2322 (e.g., transmitting/transmission circuitry) and a receiver 2324 (e.g., receiving/reception circuitry) and may be configured to transmit and/or receive time and/or frequency resource partitioning information. The transceiver 2320 may be configured to transmit in different types of subframes and slots including, but not limited to, usable, non-usable, and flexibly usable subframes and slot formats. The transceiver 2320 may be configured to receive data and control channels.

The node 2300 may include a variety of computer-readable media. Computer-readable media may be any available media that may be accessed by the node 2300 and include volatile (and/or non-volatile) media and removable (and/or non-removable) media.

The computer-readable media may include computer-storage media and communication media. Computer-storage media may include both volatile (and/or non-volatile media), and removable (and/or non-removable) media implemented in any method or technology for storage of information such as computer-readable instructions, data structures, program modules, or data.

Computer-storage media may include RAM, ROM, EPROM, EEPROM, flash memory (or other memory technology), CD-ROM, Digital Versatile Disks (DVD) (or other optical disk storage), magnetic cassettes, magnetic tape, magnetic disk storage (or other magnetic storage devices), etc. Computer-storage media may not include a propagated data signal. Communication media may typically embody computer-readable instructions, data structures, program modules, or other data in a modulated data signal, such as a carrier wave, or other transport mechanisms and include any information delivery media.

The term “modulated data signal” may mean a signal that has one or more of its characteristics set or changed in such a manner as to encode information in the signal. Communication media may include wired media, such as a wired network or direct-wired connection, and wireless media, such as acoustic, RF, infrared, and other wireless media. Combinations of any of the previously listed components should also be included within the scope of computer-readable media.

The memory 2334 may include computer-storage media in the form of volatile and/or non-volatile memory. The memory 2334 may be removable, non-removable, or a combination thereof. Example memory may include solid-state memory, hard drives, optical-disc drives, etc. As illustrated in FIG. 23, the memory 2334 may store a computer-readable and/or computer-executable instructions 2332 (e.g., software codes) that are configured to, when executed, cause the processor 2328 to perform various functions disclosed herein. Alternatively, the instructions 2332 may not be directly executable by the processor 2328 but may be configured to cause the node 2300 (e.g., when compiled and executed) to perform various functions disclosed herein.

The processor 2328 (e.g., having processing circuitry) may include an intelligent hardware device, e.g., a Central Processing Unit (CPU), a microcontroller, an ASIC, etc. The processor 2328 may include memory. The processor 2328 may process the data 2330 and the instructions 2332 received from the memory 2334, and information transmitted and received via the transceiver 2320, the baseband communications module, and/or the network communications module. The processor 2328 may also process information to send to the transceiver 2320 for transmission via the antenna 2336 to the network communications module for transmission to a CN.

One or more presentation components 2329 may present data indications to a person or another device. Examples of presentation components 2329 may include a display device, a speaker, a printing component, a vibrating component, etc.

In view of the present disclosure, it is obvious that various techniques may be used for implementing the disclosed concepts without departing from the scope of those concepts. Moreover, while the concepts have been disclosed with specific reference to certain implementations, a person of ordinary skill in the art may recognize that changes may be made in form and detail without departing from the scope of those concepts. As such, the disclosed implementations are to be considered in all respects as illustrative and not restrictive. It should also be understood that the present disclosure is not limited to the particular implementations disclosed and many rearrangements, modifications, and substitutions are possible without departing from the scope of the present disclosure.

The various foregoing example embodiments and modes may be utilized in conjunction with one another, e.g., in combination with one another.

Each of a program running on the BS and the terminal device according to an aspect of the present invention may be a program that controls a CPU and the like, such that the program causes a computer to operate in such a manner as to realize the functions of the above-described embodiment according to the present invention. The information handled in these devices is transitorily stored in a Random-Access-Memory (RAM) while being processed. Thereafter, the information is stored in various types of Read-Only-Memory (ROM) such as a Flash ROM and a Hard-Disk-Drive (HDD), and when necessary, is read by the CPU to be modified or rewritten.

It should be noted that the terminal device and the BS according to the above-described embodiment may be partially achieved by a computer. In this case, this configuration may be realized by recording a program for realizing such control functions on a computer-readable recording medium and causing a computer system to read the program recorded on the recording medium for execution.

It should be noted that it is assumed that the “computer system” mentioned here refers to a computer system built into the terminal device or the BS, and the computer system includes an OS and hardware components such as a peripheral device. Furthermore, the “computer-readable recording medium” refers to a portable medium such as a flexible disk, a magneto-optical disk, a ROM, a CD-ROM, and the like, and a storage device built into the computer system such as a hard disk.

Moreover, the “computer-readable recording medium” may include a medium that dynamically retains a program for a short period of time, such as a communication line that is used to transmit the program over a network such as the Internet or over a communication line such as a telephone line, and may also include a medium that retains a program for a fixed period of time, such as a volatile memory within the computer system for functioning as a server or a client in such a case. Furthermore, the program may be configured to realize some of the functions described above, and also may be configured to be capable of realizing the functions described above in combination with a program already recorded in the computer system.

Furthermore, the BS according to the above-described embodiment may be achieved as an aggregation (a device group) including multiple devices. Each of the devices configuring such a device group may include some or all of the functions or the functional blocks of the BS according to the above-described embodiment. The device group may include each general function or each functional block of the BS. Furthermore, the terminal device according to the above-described embodiment can also communicate with the base station device as the aggregation.

Furthermore, the BS according to the above-described embodiment may serve as an Evolved Universal Terrestrial Radio Access Network (E-UTRAN) and/or NG-RAN (Next Gen RAN, NR-RAN). Furthermore, the BS according to the above-described embodiment may have some or all of the functions of a node higher than an eNodeB or the gNB.

Furthermore, some or all portions of each of the terminal device and the base station device according to the above-described embodiment may be typically achieved as a large-scale integration (LSI) which is an integrated circuit or may be achieved as a chip set. The functional blocks of each of the terminal device and the BS may be individually achieved as a chip, or some or all of the functional blocks may be integrated into a chip. Furthermore, a circuit integration technique is not limited to the LSI, and may be realized with a dedicated circuit or a general-purpose processor. Furthermore, in a case that with advances in semiconductor technology, a circuit integration technology with which an LSI is replaced appears, it is also possible to use an integrated circuit based on the technology.

Furthermore, according to the above-described embodiment, the terminal device has been described as an example of a communication device, but the present invention is not limited to such a terminal device, and is applicable to a terminal device or a communication device of a fixed-type or a stationary-type electronic device installed indoors or outdoors, for example, such as an Audio-Video (AV) device, a kitchen device, a cleaning or washing machine, an air-conditioning device, office equipment, a vending machine, and other household devices.

The embodiments of the present invention have been described in detail above referring to the drawings, but the specific configuration is not limited to the embodiments and includes, for example, an amendment to a design that falls within the scope that does not depart from the gist of the present invention. Furthermore, various modifications are possible within the scope of one aspect of the present invention defined by claims, and embodiments that are made by suitably combining technical means disclosed according to the different embodiments are also included in the technical scope of the present invention. Furthermore, a configuration in which constituent elements, described in the respective embodiments and having mutually the same effects, are substituted for one another is also included in the technical scope of the present invention.

What is claimed is:

1. A user equipment (UE), comprising:
one or more non-transitory computer-readable media storing one or more computer-executable instructions; and
at least one processor coupled to the one or more non-transitory computer-readable media, and configured to execute the one or more computer-executable instructions to cause the UE to:
receive, from a base station (BS), information defining first and second time and frequency physical resource block (PRB)/virtual resource block (VRB) bundle grids for allocating resources to a physical transmission channel;
assign a first plurality of VRB bundle indices associated with a first channel bandwidth segment of the physical transmission channel;
assign a second plurality of VRB bundle indices associated with a second channel bandwidth segment of the physical transmission channel;
map the first plurality of VRB bundle indices into a first plurality of PRB resource block bundles in the first time and frequency PRB/VRB bundle grid; and
map the second plurality of VRB bundle indices into a second plurality of PRB resource block bundles in the second time and frequency PRB/VRB bundle grid.

2. The UE of claim 1, wherein:
wherein the first plurality of PRB resource block bundles is not interleaved with the second plurality of PRB resource block bundles.

3. The UE of claim 1, wherein:
the first plurality of VRB bundle indices is mapped into the first plurality of PRB resource block bundles using a first interleaver, and
the second plurality of VRB bundle indices is mapped into the second plurality of PRB resource block bundles using a second interleaver.

4. The UE of claim 3, wherein:
the first interleaver uses a first nominal bundle size defining a number of PRBs in each PRB resource block bundle in the first plurality of PRB resource block bundles, and
the second interleaver uses a second nominal bundle size defining a number of PRBs in each PRB resource block bundle in the second plurality of PRB resource block bundles.

5. The UE of claim 1, wherein:
the first and second plurality of VRB bundle indices are separately mapped into the first and second plurality of PRB resource block bundles, respectively, using a same interleaver.

6. The UE of claim 1, wherein:
the physical transmission channel is one of a physical downlink shared channel (PDSCH) a physical uplink shared channel (PUSCH), a physical downlink control channel (PDCCH), or a physical uplink control channel (PUCCH).

7. The UE of claim 1, wherein:
the at least one processor is further configured to execute the one or more computer-executable instructions to cause the UE to:
receive, from the BS, the information defining the first and second time and frequency PRB/VRB bundle grids via one of a radio resource control (RRC) signaling, a system information block (SIB), a physical broadcast channel (PBCH), a master information block (MIB), or a downlink control information (DCI).

8. The UE of claim 1, wherein:
the at least one processor is further configured to execute the one or more computer-executable instructions to cause the UE to:
transmit, to the BS, an uplink message in the first channel bandwidth segment using the first plurality of PRB resource block bundles; and
transmit, to the BS, an uplink message in the second channel bandwidth segment using the second plurality of PRB resource block bundles.

9. The UE of claim 1, wherein:
the at least one processor is further configured to execute the one or more computer-executable instructions to cause the UE to:
simultaneously transmit, to the BS, an uplink message in the first channel bandwidth segment using the first plurality of PRB resource block bundles and in the second channel bandwidth segment using the second plurality of PRB resource block bundles in time division duplex (TDD).

10. The UE of claim 1, wherein:
the at least one processor is further configured to execute the one or more computer-executable instructions to cause the UE to:
receive, from the BS, a downlink message in the first channel bandwidth segment using the first plurality of PRB resource block bundles; and
receive, from the BS, a downlink message in the second channel bandwidth segment using the second plurality of PRB resource block bundles.

11. The UE of claim 1, wherein:
the at least one processor is further configured to execute the one or more computer-executable instructions to cause the UE to:
simultaneously receive, from the BS, a downlink message in the first channel bandwidth segment using the first plurality of PRB resource block bundles and in the second channel bandwidth segment using the second plurality of PRB resource block bundles in time division duplex (TDD).

12. The UE of claim 1, wherein:
the first and second channel bandwidth segments are non-contiguous.

13. The UE of claim 1,
wherein the at least one processor is further configured to execute the one or more computer-executable instructions to cause the UE to:
assign the first plurality of PRB resource block bundles, in an interleaving manner, starting at a first resource block index counted from a first reference point,
wherein a number of resource block bundles in a first PRB resource block bundle in the first plurality of PRB resource block bundles comprises a nominal resource block bundle size minus a modulo of the first resource block index and the nominal resource block bundle size of the first channel bandwidth segment,
wherein, in a case that a modulo of the first resource block index plus a number of resource blocks in the first channel bandwidth segment and the nominal resource block bundle size of the first channel bandwidth segment is greater than zero, a number of resource block bundles in a last PRB resource block bundle in the first plurality of PRB resource block bundles comprises a modulo of the first resource block index plus a number of resource blocks in the first channel bandwidth segment and the nominal resource block bundle size of the first channel bandwidth segment, and
wherein, in a case that the modulo of the first resource block index plus the number of resource blocks in the first channel bandwidth segment and the nominal resource block bundle size of the first channel bandwidth segment is not greater than zero, the number of resource block bundles in the last PRB resource block bundle in the first plurality of PRB resource block bundles comprises the nominal resource block bundle size of the first channel bandwidth segment.

14. The UE of claim 1,
wherein the at least one processor is further configured to execute the one or more computer-executable instructions to cause the UE to:
assign the second plurality of PRB resource block bundles, in an interleaving manner, starting at a second resource block index counted from a second reference point,
wherein a number of resource block bundles in a first PRB resource block bundle in the second plurality of PRB resource block bundles comprises a nominal resource block bundle size minus a modulo of the second resource group index and the nominal resource block bundle size of the second channel bandwidth segment,
wherein, in a case that a modulo of the second resource block index plus a number of resource blocks in the second channel bandwidth segment and the nominal resource block bundle size of the second channel bandwidth segment is greater than zero, a number of resource block bundles in a last PRB resource block bundle in the second plurality of PRB resource block bundles comprises a modulo of the second resource block bundle index plus a number of resource blocks in the second channel bandwidth segment and the nominal resource block bundle size of the second channel bandwidth segment, and
wherein, in a case that the modulo of the second resource block index plus the number of resource blocks in the second channel bandwidth segment and the nominal resource block bundle size of the second channel bandwidth segment is not greater than zero, the number of resource block bundles in the last PRB resource block bundle in the second plurality of PRB resource block bundles comprises the nominal resource block bundle size of the second channel bandwidth segment.

15. A method, comprising:
receiving, by a user equipment (UE), from a base station (BS), information defining first and second time and frequency physical resource block (PRB)/virtual resource block (VRB) bundle grids for allocating resources to a physical transmission channel;
assigning a first plurality of VRB bundle indices associated with a first channel bandwidth segment of the physical transmission channel;
assigning a second plurality of VRB bundle indices associated with a second channel bandwidth segment of the physical transmission channel;
mapping the first plurality of VRB bundle indices into a first plurality of PRB resource block bundles in the first time and frequency PRB/VRB bundle grid; and
mapping the second plurality of VRB bundle indices into a second plurality of PRB resource block bundles in the second time and frequency PRB/VRB bundle grid.
